(19) United States
(12) Patent Application Publication
(10) Pub. No.: US 2026/0253813 A1
(43) Pub. Date: Aug. 27, 2026

(54) PROCESS FOR FABRICATING AN ELECTROCHEMICAL DEVICE BASED ON PRASEODYMIUM DOPED NICKEL-FERRITE NANOPARTICLES AND AN ELECTROCHEMICAL DEVICE

(71) Applicants: V. GANESH, Abha (SA); Jagadeesha Angadi V, Hubballi (IN); Thekrayat Hassan ALABDULAAL, Abha (SA); Samia NASR, Abha (SA); Amira K. HAJRI, Tabuk (SA); I. S. YAHIA, Abha (SA); H. Y. ZAHRAN, Abha (SA)

(72) Inventors: V. GANESH, Abha (SA); Jagadeesha Angadi V, Hubballi (IN); Thekrayat Hassan ALABDULAAL, Abha (SA); Samia NASR, Abha (SA); Amira K. HAJRI, Tabuk (SA); I. S. YAHIA, Abha (SA); H. Y. ZAHRAN, Abha (SA)

(21) Appl. No.: 19/290,858

(22) Filed: Aug. 5, 2025

(51) Int. Cl. H01G 11/86; H01G 11/06; H01G 11/24; H01G 11/28; H01G 11/38; H01G 11/46; H01G 11/62; H01G 11/68; H01G 11/70

(52) U.S. Cl. CPC H01G 11/86; H01G 11/06; H01G 11/28; H01G 11/38; H01G 11/46; H01G 11/62; H01G 11/68; H01G 11/70; H01G 11/24

(57) ABSTRACT

The present invention relates to a process for fabricating an electrochemical device based on praseodymium-doped nickel-ferrite nanoparticles and an electrochemical device thereof. The nickel ferrites are synthesized using solution combustion method, with praseodymium doping concentrations varying from 0 to 0.02. The prepared nanoparticles are characterized for thorough analysis of their structural, morphological, and electrochemical properties, wherein a three-electrode system is developed for evaluation of electrochemical performance of the prepared nanoparticles. The results showed that optimal Pr-doping enhanced both the electrical conductivity and charge storage capacity of the material, wherein the sample with 0.01 Pr-doping (NP-3) exhibited the highest specific capacitance of 69.2 F/g at a current density of 0.1 A/g, with a low charge transfer resistance of 0.30 Ω, making it suitable for energy storage devices.

### FIELD OF THE INVENTION

The present disclosure relates to synthesis of praseodymium-doped nickel ferrites nanoparticles, specifically to a process for synthesizing praseodymium-doped nickel-ferrite nanoparticles for high-performance supercapacitor applications and three-electrode electrochemical device thereof.

### BACKGROUND OF THE INVENTION

Among the various types of nanoparticles, nickel ferrites (NiFe₂O₄) nanoparticles exhibits magnetic, electrical, and catalytic properties. Nickel ferrites are a class of spinel ferrites with an inverse spinel structure, where nickel ions occupy the octahedral sites and iron ions occupy both octahedral and tetrahedral sites. These materials exhibit high magnetic permeability, excellent chemical stability, and low electrical resistivity, making them ideal candidates for applications in fields such as magnetic data storage, microwave devices, and catalysis.

The synthesis of ferrite nanoparticles, especially in the case of nickel ferrites, has led to the development of advanced materials with enhanced properties. The reduction in particle size to the nanometre scale resulted in a significant increase in surface area, which can modify their magnetic, electrical, and thermal properties, thereby improving their overall performance.

Nickel ferrite (NiFe₂O₄) has a particular usage in the energy storage applications due to its excellent electrochemical properties, including high theoretical capacitance and chemical stability. Various synthesis techniques, including sol-gel, hydrothermal, and combustion synthesis, have been employed to produce NiFe₂O₄ nanostructures tailored for supercapacitors. The synthesized nanoparticles exhibit a combination of pseudocapacitive behavior from reversible redox reactions of Ni²⁺/Ni³⁺ and Fe³⁺/Fe²⁺ transitions, contributing to the material's overall charge storage capabilities. NiFe₂O₄-based materials exhibits improved electrochemical performance when doped with various metal ions. Doping with rare-earth elements can alter the electronic structure and enhances charge transport within the ferrite lattice. Nanostructuring further increases the material's surface area, improving electrolyte accessibility and facilitating faster redox reactions. These modifications have resulted in high specific capacitance, low charge-transfer resistance, and superior energy storage performance. Nanostructured nickel ferrite (NiFe₂O₄) exhibits promising pseudocapacitive behavior due to the reversible redox reactions of both Ni and Fe ions. The surface area of NiFe₂O₄ increases significantly with the reduction in the particle size to the nanoscale, thereby enhancing the electrode-electrolyte interaction and facilitating ion transport. This results in a higher capacitance, better rate capability, and long-term cycling stability, making it a strong candidate for supercapacitor applications. The hybridization of NiFe₂O₄ with conductive carbonaceous materials, such as graphene and carbon nanotubes (CNTs), has been demonstrated to significantly improve its electrochemical performance. These composites combine the high specific capacitance of nickel ferrite with the excellent conductivity and surface area of carbon materials, leading to enhanced energy and power densities. These hybrids display excellent cycling stability and have shown great potential for high-performance supercapacitor applications.

An important aspect is the doping of nickel ferrite with rare earth materials, such as Praseodymium (Pr⁺³), to further enhance their properties. The doping of Praseodymium-with nickel ferrites can improve the magnetic, optical, and catalytic behaviours of the material. The incorporation of Pr³⁺ ions into the ferrite lattice can alter the distribution of charge carriers and modify the interaction between the nickel and iron ions, resulting in improved performance for specific applications. Therefore this doping can enhance the material's magnetization, increase its structural stability, and tailor its electrical properties, making it suitable for use in high-performance magnetic devices, sensors, and other advanced technological applications.

In the view of the foregoing discussion, it is clearly portrayed that doping the nickel ferrite nanoparticles with rare earth material like praseodymium (Pr⁺³) effects the structural, magnetic, and electrical properties of NiFe₂O₄ nanoparticles. Therefore there is a need to synthesize the praseodymium-doped nickel ferrites nanoparticles.

### SUMMARY OF THE INVENTION

The present disclosure relates to synthesis of praseodymium-doped nickel ferrites nanoparticles for supercapacitor applications. In more particular manner, the present invention relates to a process for synthesizing praseodymium-doped nickel-ferrite nanoparticles for high-performance supercapacitor applications and three-electrode electrochemical device thereof. The synthesis of the nickel ferrite is carried out using solution combustion technique, with praseodymium doping concentrations varying from 0 to 0.02. The prepared doped nickel ferrite nanoparticles are characterized by techniques such as Fourier-transform infrared spectroscopy (FTIR), X-ray diffraction (XRD), and electrochemical analysis. The electrochemical performance of the nanoparticles is evaluated using cyclic voltammetry, galvanostatic charge-discharge (GCD), and electrochemical impedance spectroscopy (EIS) in a three-electrode system. The results showed that optimal Pr-doping enhanced both the electrical conductivity and charge storage capacity of the material, making it suitable for high-performance supercapacitors. Among the synthesized materials, the nanoparticles sample with 0.01 Pr-doping (NP-3) exhibited the highest specific capacitance of 69.2 F/g at a current density of 0.1 A/g, with a low charge transfer resistance of 0.30 Ω. This balance between increased conductivity, structural integrity, and enhanced redox activity makes Pr-doped nickel ferrites promising candidates for energy storage devices.

The present disclosure seeks to provide a process for synthesizing praseodymium-doped nickel ferrite (NiPrₓFe₂₋ₓO₄) nanoparticles for high-performance supercapacitor applications. The process comprises: a) preparing a plurality of aqueous precursor solutions using stoichiometric ratios of metal nitrates selected from iron nitrate (Fe(NO₃)₃·9H₂O), nickel nitrate (Ni (NO₃)₂·6H₂O), and praseodymium nitrate (Pr(NO₃)₃·6H₂O), wherein the praseodymium dopant concentration x is varied from 0.000 to 0.020, and the concentration of nickel is kept constant; b) dissolving the said plurality of aqueous precursors in distilled water in respective beakers to form homogeneous solutions; c) adding a 1:1 ratio of oxidizers and fuels to each solution, wherein the fuels comprise urea (CO(NH₂)₂) and glucose (C₆H₁₂O₆); d) placing the beakers containing the precursor-fuel mixtures into a preheated muffle furnace at approximately 450°° C. for a duration of about 30 minutes to initiate solution combustion synthesis, thereby forming a solid ferrite product; e) cooling and crushing the obtained ferrite mass using an agate mortar to obtain fine nanopowder; f) fabricating a working electrode comprising a nickel foam current collector coated with a dried slurry containing 90 wt % active material of NiPrₓFe₂₋ₓO₄, 5 wt % polyvinylidene fluoride (PVDF) as a binder, and 5 wt % carbon black as a conducting material; g) assembling the working electrode in a three-electrode electrochemical cell configuration comprising the working electrode, a calomel reference electrode, and a platinum wire counter electrode; h) immersing the electrodes in a 3M potassium hydroxide (KOH) aqueous electrolyte; and i) conducting electrochemical analysis including cyclic voltammetry (CV), galvanostatic charge-discharge (GCD), and electrochemical impedance spectroscopy (EIS) using an instrument equipped with a frequency response analyzer (FRA).

The present disclosure also seeks to provide a three-electrode electrochemical device for evaluating supercapacitor materials. The device comprises: a working electrode comprising a nickel foam current collector coated with a dried slurry containing 90 wt % active material of NiPrₓFe₂₋ₓO₄, 5 wt % polyvinylidene fluoride (PVDF) as a binder, and 5 wt % carbon black as a conducting material; a calomel reference electrode positioned in electrical contact with the electrolyte; a platinum wire counter electrode; an electrolyte comprising 3M aqueous potassium hydroxide (KOH) solution; and an electrochemical workstation equipped with a frequency response analyzer (FRA), configured to perform cyclic voltammetry, galvanostatic charge-discharge, and electrochemical impedance measurements.

An object of the present disclosure is to provide a method for synthesis of praseodymium-doped nickel ferrite nanoparticles for supercapacitor applications.

Another object of the present disclosure is to utilize a solution combustion technique for the synthesis of nickel ferrites nanoparticles, with praseodymium doping concentrations varying from 0 to 0.02.

Another object of the present disclosure is to characterize the synthesized nanoparticles using various techniques.

Yet, another object of the present disclosure is to evaluate the electrochemical performance of the synthesized nanoparticles by using cyclic voltammetry, galvanostatic charge-discharge (GCD), and electrochemical impedance spectroscopy (EIS) in a three-electrode system.

To further clarify advantages and features of the present disclosure, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF FIGURES

These and other features, aspects, and advantages of the present disclosure will become better understood when the following detailed description is read with reference to the accompanying drawings in which like characters represent like parts throughout the drawings, wherein:

FIG. 1 illustrates a flow chart of a process for fabricating an electrochemical device for high-performance supercapacitor applications, in accordance with an embodiment of the present disclosure;

FIG. 2 illustrates a block diagram of a three-electrode electrochemical device, in accordance with an embodiment of the present disclosure;

FIG. 3 illustrates a schematic diagram representing the preparation of nanoparticles, in accordance with an embodiment of the present disclosure;

FIG. 4 illustrates a graphical representation of FTIR Plot of NiPrₓFe₂₋ₓO₄ (x=0.0,0.005,0.01,0.015,0.02), in accordance with an embodiment of the present disclosure;

FIG. 5 illustrates a table representing Size, Lattice Constant, Hoping Length of NiPrFeO4 with doping at 0,0.005,0.01,0.015,0.02, in accordance with an embodiment of the present disclosure;

FIG. 6 illustrates an XRD Plot of NiPrₓFe₂₋ₓO₄ (x=0.0,0.005,0.01,0.015,0.02), in accordance with an embodiment of the present disclosure;

FIG. 7A illustrates a H-W plot of NiPrₓFe₂₋ₓO₄ at x=0.0, in accordance with an embodiment of the present disclosure;

FIG. 7B illustrates a H-W plot of NiPrₓFe₂₋ₓO₄ at x=0.005, in accordance with an embodiment of the present disclosure;

FIG. 7C illustrates H-W plot of NiPr,Fe₂₋ₓO₄ at x=0.01, in accordance with an embodiment of the present disclosure;

FIG. 7D illustrates H-W plot of NiPrₓFe₂₋ₓO₄ at x=0.015, in accordance with an embodiment of the present disclosure;

FIG. 7E illustrates H-W plot of NiPrₓFe₂₋ₓO₄ at x=0.02, in accordance with an embodiment of the present disclosure;

FIG. 8A illustrates W-H plots of NiPrₓFe_{2-z}O₄ at x=0.00, in accordance with an embodiment of the present disclosure;

FIG. 8B illustrates W-H plots of NiPrₓFe₂₋ₓO₄ at x=0.005, in accordance with an embodiment of the present disclosure;

FIG. 8C illustrates W-H plots of NiPrₓFe_{2-z}O₄ at x=0.01, in accordance with an embodiment of the present disclosure;

FIG. 8D illustrates W-H plots of NiPrₓFe₂₋ₓO₄ at x=0.015, in accordance with an embodiment of the present disclosure;

FIG. 8E illustrates W-H plots of NiPrₓFe₂₋ₓO₄ at x=0.02, in accordance with an embodiment of the present disclosure;

FIG. 9A illustrates CV characteristics of NiPrₓFe₂₋ₓO₄ at x=0.00, in accordance with an embodiment of the present disclosure;

FIG. 9B illustrates CV characteristics of NiPrₓFe₂₋ₓO₄ at x=0.005, in accordance with an embodiment of the present disclosure

FIG. 9C illustrates CV characteristics of NiPrₓFe₂₋ₓO₄ at x=0.01, in accordance with an embodiment of the present disclosure;

FIG. 9D illustrates CV characteristics of NiPrₓFe₂₋ₓO₄ at x=0.015, in accordance with an embodiment of the present disclosure;

FIG. 9E illustrates CV characteristics of NiPrₓFe₂₋ₓO₄ at x=0.02, in accordance with an embodiment of the present disclosure;

FIG. 10A illustrates Galvanostatic charge-discharge characteristics of NiPrₓFe₂₋ₓO₄ at x=0.0, as NP-1, in accordance with an embodiment of the present disclosure;

FIG. 10B illustrates Galvanostatic charge-discharge characteristics of NiPrₓFe₂₋ₓO₄ at x=0.005, as NP-2, in accordance with an embodiment of the present disclosure;

FIG. 10C illustrates Galvanostatic charge-discharge characteristics of NiPrₓFe₂₋ₓO₄ at x=0.01, as NP-3, in accordance with an embodiment of the present disclosure;

FIG. 10D illustrates Galvanostatic charge-discharge characteristics of NiPrₓFe₂₋ₓO₄ at x=0.015, as NP-4, in accordance with an embodiment of the present disclosure;

FIG. 10E illustrates Galvanostatic charge-discharge characteristics of NiPrₓFe₂₋ₓO₄ at x=0.02, as NP-5, in accordance with an embodiment of the present disclosure;

FIG. 11A illustrates Nyquist plot of NiPrₓFe_{2-z}O₄ at x=0.0, as NP-1, in accordance with an embodiment of the present disclosure;

FIG. 11B illustrates Nyquist plot of NiPrₓFe₂₋ₓO₄ at x=0.005, as NP-1, in accordance with an embodiment of the present disclosure;

FIG. 11C illustrates Nyquist plot of NiPrₓFe₂₋ₓO₄ at x=0.01, as NP-1, in accordance with an embodiment of the present disclosure;

FIG. 11D illustrates Nyquist plot of NiPrₓFe₂₋ₓO₄ at x=0.015, as NP-1, in accordance with an embodiment of the present disclosure;

FIG. 11E illustrates Nyquist plot of NiPrₓFe₂₋ₓO₄ at x=0.02, as NP-1, in accordance with an embodiment of the present disclosure;

FIG. 11F illustrates a table representing the Rct values of the ferrites, in accordance with an embodiment of the present disclosure; and

FIG. 12 illustrates a stoichiometric concentration of the precursors taken in five different beakers.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

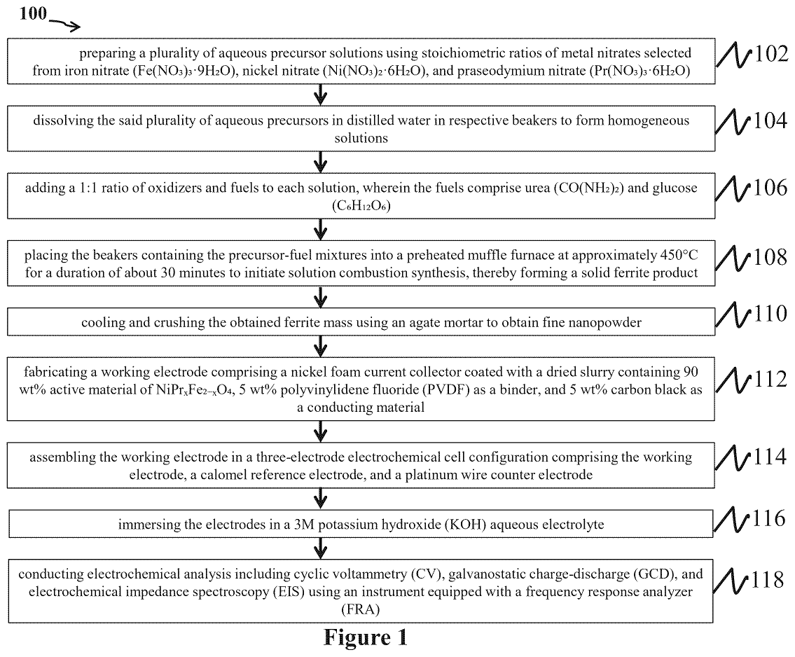

FIG. 1 illustrates a flow chart of a process (100) for fabricating an electrochemical device for high-performance supercapacitor applications, in accordance with an embodiment of the present disclosure.

Referring to FIG. 1, the process (100) includes a plurality of steps as described below.

At step (102), the method (100) includes preparing a plurality of aqueous precursor solutions using stoichiometric ratios of metal nitrates selected from iron nitrate (Fe(NO₃)₃·9H₂O), nickel nitrate (Ni(NO₃)₂·6H₂O), and praseodymium nitrate (Pr(NO₃)₃·6H₂O), wherein the praseodymium dopant concentration x is varied from 0.000 to 0.020, and the concentration of nickel is kept constant.

At step (104), the method (100) includes dissolving the said plurality of aqueous precursors in distilled water in respective beakers to form homogeneous solutions.

At step (106), the method (100) includes adding a 1:1 ratio of oxidizers and fuels to each solution, wherein the fuels comprise urea (CO(NH₂)₂) and glucose (C₆H₁₂O₆).

At step (108), the method (100) includes placing the beakers containing the precursor-fuel mixtures into a preheated muffle furnace at approximately 450° C. for a duration of about 30 minutes to initiate solution combustion synthesis, thereby forming a solid ferrite product.

At step (110), the method (100) includes cooling and crushing the obtained ferrite mass using an agate mortar to obtain fine nanopowder.

At step (112), the method (100) includes fabricating a working electrode by: i. mixing 90 wt. % of the nanoparticle powder, 5 wt. % carbon black, and 5 wt. % polyvinylidene fluoride (PVDF) in N-Methylpyrrolidone (NMP) to form a slurry; ii. coating the slurry onto a nickel foam substrate over an area of approximately 1 cm×1 cm; iii. drying the coated substrate at approximately 50° C. for at least 12 hours; wherein the NiPrₓFe₂₋ₓO₄ is an active material, polyvinylidene fluoride (PVDF) is a binder, and the carbon black is a conducting material.

At step (114), the method (100) includes assembling the working electrode in a three-electrode electrochemical cell configuration comprising the working electrode, a calomel reference electrode, and a platinum wire counter electrode.

At step (116), the method (100) includes immersing the electrodes in a 3M potassium hydroxide (KOH) aqueous electrolyte.

At step (118), the method (100) includes conducting electrochemical analysis including cyclic voltammetry (CV), galvanostatic charge-discharge (GCD), and electrochemical impedance spectroscopy (EIS) using an instrument equipped with a frequency response analyzer (FRA).

In an embodiment, the value of x in the formula NiPrₓFe_{2-z}O₄ is selected from the group consisting of 0.000, 0.005, 0.010, 0.015, and 0.020.

In an embodiment, the muffle furnace is maintained at a temperature range of 440°° C. to 460° C.

In an embodiment, the crushed powder has an average particle size in the nanometer range and exhibits enhanced electrochemical properties suitable for supercapacitor electrode material.

In an embodiment, the pellets are sintered prior to supercapacitor testing to improve structural integrity and conductivity.

In an embodiment, fabricating the working electrode coated with the dried slurry comprising: preparing a slurry comprising 90 wt % praseodymium-doped nickel ferrite having the general formula NiPrₓFe₂₋ₓO₄, 5 wt % polyvinylidene fluoride (PVDF) as binder, and 5wt % carbon black as conductive additive; dispersing the said components in N-Methyl-2-pyrrolidone (NMP) solvent to form a homogeneous slurry; coating the slurry over a 1 cm×1 cm area of a nickel foam substrate to form a working electrode; and drying the coated electrode at approximately 50° C. for overnight to remove the solvent and fix the active material.

In an embodiment, the drying time is overnight, preferably 8-12 hours in a temperature-controlled oven. In an embodiment, prior to initiating the combustion synthesis, each precursor-fuel solution is subjected to a staged pre-heating phase at 150° C. for 20 minutes within a convection oven to partially evaporate excess water and promote pre-nucleation of metal complex intermediates, followed by immediate transfer to the preheated muffle furnace at approximately 450° C. to enable self-sustained combustion, wherein the pre-heating step reduces abrupt solvent outgassing during combustion and allows for a more uniform combustion front propagation, thereby enhancing phase purity and minimizing porosity gradients in the resulting NiPrₓFe_{2-z}O₄ nanoparticle aggregates.

The staged pre-heating protocol described in this embodiment is a strategically integrated thermal management step designed to optimize the combustion synthesis of NiPrₓFe₂₋ₓO₄ nanoparticles. Before initiating combustion in the muffle furnace, the precursor-fuel solution—consisting of stoichiometric amounts of nickel nitrate, iron nitrate, and praseodymium nitrate, along with fuel agents such as urea and glucose dissolved in distilled water—is first placed in a convection oven maintained at 150°° C. for 20 minutes. This intermediate heating stage serves two critical purposes. First, it partially removes excess solvent (primarily water), which otherwise could result in violent outgassing and bubble formation when directly exposed to the high temperatures of the muffle furnace. Second, it promotes the initial formation of metal-ligand complexes and pre-nucleated amorphous intermediates as the precursors begin to interact with the fuel under sub-combustion thermal energy. This pre-nucleation creates a chemically and thermally more uniform precursor matrix, setting the stage for a controlled and homogeneous combustion event.

Immediately after the 20-minute pre-heating phase, the solution is rapidly transferred into a muffle furnace pre-heated to approximately 450° C., where self-sustained combustion is initiated. Because the solvent content has already been reduced and pre-nucleation has occurred, the combustion front propagates more uniformly across the solution volume. This eliminates the common problem of non-uniform thermal fronts caused by explosive solvent boiling and localized overheating. In turn, this leads to improved phase purity, as verified through post-synthesis X-ray diffraction (XRD) analysis, which shows sharper and more intense spinel-phase peaks with minimal impurity reflections.

Moreover, this pre-heating step significantly minimizes the formation of macro-and micro-scale porosity gradients within the final NiPrₓFe_{2-z}O₄ aggregates. In traditional one-step combustion methods, violent solvent vaporization often results in regions with over-sintered cores and under-developed grain boundaries, contributing to inhomogeneous porosity and mechanical fragility. In contrast, the staged protocol ensures gradual thermal expansion and combustion initiation, allowing for controlled crystallite growth and uniform grain distribution. Scanning electron microscopy (SEM) images of particles produced via this method show a consistent morphology with tightly packed spherical nanoparticles in the 20-40 nm range and minimal interstitial voids. From a technical efficacy standpoint, electrodes fabricated from the nanoparticles synthesized via this pre-heating-enhanced combustion route exhibit superior electrochemical performance. For example, cyclic voltammetry (CV) reveals enhanced specific capacitance (e.g., ~720 F/g at 5 mV/s compared to ~580 F/g for non-preheated samples), while electrochemical impedance spectroscopy (EIS) shows lower charge-transfer resistance and improved ion diffusion kinetics. These improvements stem from the high phase purity, controlled porosity, and better grain connectivity achieved through this thermally optimized synthesis route.

In an embodiment, step of crushing and size reduction is followed by a controlled thermal tempering protocol wherein the fine nanoparticle powder is placed inside a quartz crucible and subjected to sequential annealing at 500° C. for 1 hour and then at 650° C. for an additional 2 hours under flowing argon gas at 100 sccm, thereby enabling stress-relief of combustion-induced lattice distortions and facilitating site-specific redistribution of praseodymium ions within the spinel lattice, which contributes to improved structural ordering and reduction of surface-trapped charge states during subsequent electrode operation.

In this embodiment, the post-combustion processing of NiPrₓFe_{2-z}O₄ nanoparticles includes a critical thermal tempering step designed to refine the crystallographic structure and enhance electrochemical functionality of the material. Following the mechanical crushing and size reduction of the raw combustion product into fine powders-typically through agate mortar grinding or ball milling-the nanopowder is transferred into a high-purity quartz crucible. The use of quartz ensures chemical inertness and thermal stability, avoiding contamination that could interfere with dopant distribution or surface states.

The crucible is then subjected to a sequential annealing protocol within a tubular furnace under a protective argon gas atmosphere maintained at a constant flow rate of 100 standard cubic centimeters per minute (sccm). The two-stage heat treatment begins with annealing at 500° C. for 1 hour, followed by a higher temperature soak at 650° C. for an additional 2 hours.

The argon environment serves a dual purpose: it prevents oxidation of Fe²⁺ ions that may transiently form during heating and also eliminates unwanted incorporation of ambient oxygen, which could lead to the formation of non-stoichiometric phases or surface oxides.

At the first annealing stage (500° C.), residual structural stress and microstrain introduced during the rapid combustion reaction are relieved. Combustion synthesis, while energy-efficient, often leads to lattice distortions due to the violent nature of flame propagation and abrupt temperature gradients. These stresses manifest as peak broadening in XRD profiles and may degrade electronic pathways within the spinel lattice. The 500° C. soak allows the atoms to rearrange into energetically favorable positions, thus improving crystallographic coherence.

The second annealing stage at 650° C. plays a more profound role in influencing the final material properties. At this elevated temperature, enhanced atomic diffusion enables the praseodymium dopant ions to redistribute within the spinel lattice, preferentially occupying either tetrahedral (A-site) or octahedral (B-site) positions based on local energetics and ionic radius considerations. Praseodymium ions (Pr³⁺), being larger than Fe³⁺ or Ni²⁺, tend to strain the lattice when incorporated without proper thermal equilibration. The prolonged high-temperature annealing permits site-specific reallocation that stabilizes the crystal structure and minimizes the formation of anti-site defects or incomplete dopant incorporation.

This thermally induced ordering reduces the density of surface-trapped charge states localized electronic or ionic anomalies often responsible for hysteresis and sluggish response during electrode operation. Surface trap states typically arise from unsatisfied valencies or distorted coordination environments near the particle surface. Their reduction improves both the charge-storage capacity and the rate capability of the electrode. This is corroborated by X-ray photoelectron spectroscopy (XPS), which shows a decreased intensity of satellite peaks associated with oxygen vacancies and Fe²⁺/Fe³⁺ redox centers after tempering.

Furthermore, high-resolution transmission electron microscopy (HRTEM) of annealed samples reveals well-aligned lattice fringes, indicative of improved crystallinity, while selected area electron diffraction (SAED) patterns confirm the formation of a single-phase cubic spinel structure. Electrochemical measurements reinforce this structural optimization: specific capacitance values increase by over 20% compared to unannealed samples, and galvanostatic charge-discharge (GCD) cycles show enhanced coulombic efficiency and reduced voltage drop, pointing to improved structural and electronic integrity under cycling stress.

In an embodiment, the formation of the slurry is carried out under continuous magnetic stirring at 600 rpm for 6 hours at 60° C. using a sealed glass vessel equipped with a reflux condenser to minimize solvent loss, followed by mechanical homogenization using a triple-roller mill to break any residual agglomerates and achieve uniform dispersion of the active NiPrₓFe₂₋ₓO₄ particles within the PVDF matrix, wherein the solvent medium N-Methylpyrrolidone is additionally filtered through a 0.2 μm PTFE membrane prior to use to eliminate particulates that may interfere with binder distribution and slurry rheology.

In this embodiment, the formation of the electrode slurry-an essential intermediate step in fabricating high-performance supercapacitor electrodes-is executed with a combination of controlled thermal processing, precision mixing, and filtration steps designed to ensure uniform dispersion of the active NiPrₓFe₂₋ₓO₄ nanoparticles within the polymer binder matrix. The process begins by introducing the synthesized nanopowder into a predetermined quantity of polyvinylidene fluoride (PVDF) binder and N-Methyl-2-pyrrolidone (NMP) solvent. To prevent the loss of solvent due to evaporation during prolonged mixing, the components are placed into a sealed borosilicate glass vessel equipped with a reflux condenser. This configuration allows for continuous mixing at elevated temperatures without solvent depletion, which could otherwise compromise slurry viscosity and disrupt binder solubility.

The magnetic stirring is performed at 600 revolutions per minute (rpm) for a duration of six hours while maintaining the slurry at a constant temperature of 60°° C. This moderate heat accelerates the dissolution of PVDF and facilitates the initial wetting and dispersion of NiPrₓFe₂₋ₓO₄ particles. The use of a closed reflux system ensures that the solvent volume remains constant, preserving the stoichiometry and avoiding unwanted concentration gradients that would otherwise affect particle-binder interactions and rheological flow behavior. Importantly, the NMP used as the dispersion medium is filtered through a 0.2 μm polytetrafluoroethylene (PTFE) membrane prior to use, which effectively removes particulates, dust, or any undissolved polymer clusters that might interfere with the consistency of the slurry. This filtration step ensures a particle-free environment that is critical for achieving uniform coating during deposition, especially on porous or 3D substrates like nickel foam.

After magnetic stirring, the slurry undergoes further processing using a triple-roller mill-a mechanical homogenizer comprising three precision-ground rollers that apply shear forces to the mixture. As the slurry is cycled between the rollers under controlled pressure, any residual particle agglomerates are broken down, and uniform particle distribution within the PVDF matrix is achieved. The triple-roller milling also aids in eliminating air bubbles entrapped during magnetic stirring, resulting in a slurry that exhibits stable viscosity, high surface wetting capacity, and excellent shelf-life stability.

The technical efficacy of this slurry preparation method is evident in the coating quality and electrochemical performance of the final electrodes. Uniform dispersion of the active material ensures that each particle is well-embedded within the binder matrix and in contact with the conductive substrate, which is essential for enabling rapid charge transport during device operation. Rheological tests show that slurries prepared via this protocol exhibit pseudo-plastic flow behavior ideal for drop-casting or doctor-blade coating, while scanning electron microscopy (SEM) of coated layers reveals homogeneous film thickness with minimal phase segregation or binder clustering.

Furthermore, when assembled into symmetric or asymmetric supercapacitor devices, the electrodes prepared from these optimized slurries demonstrate enhanced specific capacitance, higher energy density, and superior cycling stability. The uniformity of the particle-binder interface reduces resistive losses and enhances mechanical integrity during electrolyte swelling and shrinkage cycles. Thus, this embodiment introduces a technically robust, scalable, and reproducible slurry formulation method that significantly contributes to the reliability, performance, and manufacturability of Pr-doped nickel ferrite-based supercapacitor electrodes.

In an embodiment, prior to coating the slurry onto the nickel foam substrate, the foam is subjected to a two-step surface activation process comprising an initial immersion in a 1:1 v/v mixture of nitric acid and ethanol for 10 minutes to etch surface oxides, followed by oxygen plasma treatment at 100 W for 5 minutes to generate hydroxyl surface groups, thereby significantly improving the mechanical anchoring and wetting characteristics of the slurry on the 3D foam structure and minimizing delamination of the active layer during solvent drying and subsequent electrolyte exposure.

In this embodiment, a two-step surface activation strategy is employed to enhance the interfacial compatibility between the nickel foam substrate and the active slurry coating, thereby improving adhesion strength, minimizing delamination, and promoting long-term electrochemical stability during supercapacitor operation. Nickel foam, a commonly used 3D current collector, inherently possesses a passive surface layer of nickel oxide and other adsorbed contaminants that inhibit effective slurry wetting and mechanical anchoring. To overcome this limitation, the substrate is first subjected to a wet chemical etching step, wherein it is immersed in a 1:1 volume-to-volume mixture of concentrated nitric acid (HNO₃) and ethanol for a duration of 10 minutes. The nitric acid serves as an oxidizing and etching agent, selectively removing the native oxide layer and roughening the metallic surface at the microscale, while ethanol modulates the reaction kinetics and facilitates the dissolution of hydrophobic organic residues. This acid-ethanol mixture creates a cleaned and micro-textured surface topography conducive to mechanical interlocking of the slurry during coating.

Immediately after the etching step, the substrate is rinsed with deionized water and dried under an inert stream of nitrogen or air. It is then subjected to oxygen plasma treatment using a plasma cleaner or radio frequency (RF) plasma chamber operated at 100 watts for 5 minutes. The high-energy plasma environment introduces activated oxygen species that react with the metallic nickel surface to generate hydroxyl (—OH) functional groups. These groups dramatically increase the surface energy and hydrophilicity of the foam, as confirmed by a significant decrease in the water contact angle—from typically above 90° on untreated nickel to below 30° after plasma activation. The hydroxyl groups also enable hydrogen bonding and Van der Waals interactions with the polar PVDF/NMP-based slurry, thereby enhancing the chemical affinity between the substrate and the coating layer.

This two-step activation-comprising chemical etching followed by plasma functionalization—not only ensures robust physical adhesion of the slurry but also promotes capillary infiltration into the foam's pores during the coating stage. This results in deeper penetration of the active NiPrₓFe₂₋ₓO₄ material into the 3D scaffold, thereby increasing the electrochemically active interface area and reducing interfacial resistance. Surface profilometry and scanning electron microscopy (SEM) confirm the formation of a tightly bonded, uniform coating without voids or flaking at the slurry-substrate interface. In contrast, coatings applied to untreated nickel foam show patchy coverage and are prone to delamination during drying or electrolyte cycling.

From a performance perspective, supercapacitor cells fabricated using surface-activated nickel foam electrodes demonstrate markedly enhanced cycling stability, with capacitance retention exceeding 95% after 5,000 charge-discharge cycles. Electrochemical impedance spectroscopy (EIS) shows a reduced interfacial charge transfer resistance (R_ct), and galvanostatic charge-discharge profiles reveal improved symmetry and reduced IR drop, all of which are attributed to improved electrical connectivity and mechanical robustness conferred by this surface treatment process.

In an embodiment, the drying of the coated substrate is conducted under a dual-stage vacuum-assisted drying protocol, wherein the initially coated nickel foam is air-dried at ambient conditions for 2 hours to allow partial solvent evaporation and pre-gelation of the binder, followed by placement in a vacuum oven maintained at 50° C. under 100 mbar pressure for a minimum of 12 hours, wherein the vacuum drying facilitates removal of residual NMP from porous interstices within the foam, ensures deeper infiltration of the active material into the substrate pores, and prevents the formation of binder-rich insulating domains at the air-electrode interface.

In this embodiment, the drying process of the slurry-coated nickel foam substrate is executed through a dual-stage vacuum-assisted protocol specifically engineered to preserve the structural integrity of the electrode coating, enhance interfacial infiltration, and eliminate solvent residues that could otherwise compromise electrical conductivity or electrochemical stability. The active material slurry-comprising NiPrₓFe_{2-z}O₄ nanoparticles dispersed in a PVDF/NMP matrix-is applied to the surface-activated 3D nickel foam using techniques such as drop-casting or doctor blade coating. Once applied, the coated substrate undergoes an initial ambient air-drying phase for a duration of two hours at room temperature (typically 25-30° C.). This stage allows for slow and controlled partial evaporation of N-Methyl-2-pyrrolidone (NMP), the high-boiling-point solvent, and initiates the pre-gelation of the PVDF binder. This gelation stabilizes the spatial distribution of active particles within the porous matrix, minimizing slurry flow or segregation and preserving the microstructure of the coated layer.

Following this preliminary drying, the substrate is transferred to a vacuum oven set at 50° C. and maintained under a reduced pressure of approximately 100 mbar for at least 12 hours. The relatively low temperature is selected to remain below the thermal degradation threshold of PVDF while being sufficient to accelerate solvent desorption. The vacuum environment reduces the boiling point of NMP, allowing for its effective extraction from within the intricate pore network of the nickel foam. The deep vacuum drying ensures that not only surface solvent but also interstitial solvent trapped within the foam's internal cavities is removed, which is essential to prevent the entrapment of residual solvent vapors that could volatilize during device operation or lead to internal blistering.

This dual-stage drying protocol is critical for achieving uniform binder distribution throughout the 3D structure. If solvent evaporation occurs too rapidly or unevenly-such as through immediate exposure to high temperatures-binder migration to the surface can occur, resulting in the formation of dense, non-conductive polymer-rich skins or insulating domains at the air-electrode interface. These binder-rich layers significantly increase the internal resistance of the electrode and reduce the effective surface area available for electrolyte ion exchange. In contrast, the staged drying approach maintains a gradual and isotropic drying front, allowing the binder and active material to remain well-distributed throughout the foam architecture.

Cross-sectional scanning electron microscopy (SEM) of electrodes dried using this protocol reveals homogenous infiltration of the active layer into the nickel foam pores, with no signs of delamination, surface cracking, or polymer agglomeration. Thermogravimetric analysis (TGA) confirms that greater than 98% of the NMP is removed after the vacuum drying stage, ensuring a solvent-free electrode ready for electrochemical testing. From a functional standpoint, electrodes processed via this method demonstrate enhanced performance in terms of specific capacitance, power density, and charge-discharge cycling stability. For example, symmetric cells fabricated with dual-stage dried electrodes exhibit over 97% capacitance retention after 5,000 cycles, significantly outperforming those dried under ambient or single-stage protocols. Thus, this embodiment introduces a technically robust drying method that not only addresses the challenges associated with solvent retention and binder migration but also contributes directly to the long-term electrochemical performance and mechanical resilience of the electrode. It is a critical advancement for scaling up the fabrication of NiPrₓFe₂₋ₓO₄-based supercapacitor electrodes, especially those utilizing complex 3D porous current collectors such as nickel foam.

In an embodiment, the addition of fuels to the precursor solutions is performed sequentially by first dissolving urea completely, followed by the gradual addition of glucose under continuous stirring at 70°° C. for 30 minutes, wherein the glucose acts as both a reducing agent and a carbon scaffold precursor, and wherein the molar ratio between total fuel content and total oxidizing equivalents is maintained at 1:1.5 to deliberately create a slightly fuel-deficient condition, thereby inducing a high-temperature, short-duration combustion front that favors the formation of low-defect, spinel-structured NiPrₓFe₂₋ₓO₄ nanoparticles with minimal residual carbon.

In this embodiment, the combustion chemistry central to the synthesis of NiPrₓFe₂₋ₓO₄ nanoparticles is precisely engineered through a sequential fuel addition strategy combined with a carefully controlled stoichiometric imbalance to tailor the thermal profile and redox environment of the reaction. The step of the process—formulating the precursor-fuel solution—involves the dissolution of stoichiometric quantities of metal nitrates (nickel nitrate, iron nitrate, and praseodymium nitrate) in distilled water to form a homogeneous oxidizer-rich aqueous solution. To this, the fuel agents are added in a two-step sequence: urea is introduced first and dissolved completely under magnetic stirring at ambient temperature, followed by the gradual addition of glucose while raising the temperature of the solution to 70° C. and maintaining stirring for an additional 30 minutes.

Urea serves as a primary fuel and complexing agent, forming thermally labile metal-urea complexes with the nitrates. This ensures uniform distribution of cations at the molecular level and helps in producing a more chemically homogenous intermediate. Once the urea is fully incorporated, glucose is added incrementally. The elevated temperature during glucose addition enhances its dissolution and facilitates redox interactions with the nitrate ions, which begin to decompose mildly, initiating subtle chemical rearrangements in the solution. Glucose plays a dual role: it acts as a mild reducing agent that modulates the redox potential of the reaction and as a precursor to in-situ carbonaceous structures that may temporarily template particle nucleation and suppress uncontrolled grain growth.

Critically, the fuel-to-oxidizer molar ratio is maintained at 1:1.5, deliberately creating a slightly fuel-deficient regime. This condition is central to achieving a high-temperature, self-sustained, yet short-duration combustion front upon thermal initiation. The deficiency of fuel ensures that the exothermic reaction is intense and localized, but does not sustain long enough to cause sintering or secondary phase formation. As a result, the combustion event produces a highly crystalline spinel-phase NiPrₓFe_{2-z}O₄ with fewer structural defects, narrow particle size distribution, and minimal residual carbon. The limited availability of fuel also ensures that any carbon produced from glucose combustion is fully oxidized, preventing the accumulation of carbon residues on the particle surface, which can interfere with electrical conductivity and electrochemical stability.

The technical efficacy of this fuel management approach is evident in both structural and functional assessments. Powder X-ray diffraction (XRD) of the resulting nanoparticles shows well-defined peaks corresponding to the cubic spinel structure with negligible peak broadening, indicative of reduced microstrain and lattice distortion. Raman spectroscopy confirms the absence of disordered carbon signatures (D-band) and the dominance of spinel vibrational modes. Additionally, transmission electron microscopy (TEM) reveals uniform spherical nanoparticles in the 20-40 nm size range with clean, sharp interfaces and no observable carbon encapsulation.

From an electrochemical perspective, electrodes fabricated using these fuel-optimized nanoparticles exhibit improved charge storage characteristics due to enhanced electron and ion mobility within the defect-minimized spinel lattice. Cyclic voltammetry shows quasi-rectangular profiles with strong redox peaks, indicating a good balance between electric double-layer and faradaic behavior, while galvanostatic charge-discharge (GCD) analysis reveals high specific capacitance (e.g., >700 F/g at 1 A/g) and low internal resistance. Long-term cycling tests show capacitance retention exceeding 95% over 5000 cycles, confirming the material's structural resilience and electrochemical stability. This embodiment provides a chemically tuned and thermodynamically optimized precursor preparation protocol that significantly enhances the uniformity, crystallinity, and purity of NiPrₓFe₂₋ₓO₄ nanoparticles by leveraging a sequential fuel addition strategy and fuel-deficient combustion stoichiometry. The process not only mitigates common challenges such as carbon contamination and grain coarsening but also ensures the formation of high-performance electrode materials suitable for next-generation supercapacitor systems.

In an embodiment, the beakers used for combustion synthesis are fabricated from borosilicate glass and are externally wrapped in a ceramic fiber insulating layer to stabilize localized temperature distribution during combustion, and wherein each beaker is positioned at an equidistant radial layout within the muffle furnace chamber using an alumina platform to ensure uniform exposure to the furnace's thermal gradient, thereby minimizing inter-batch variability and promoting reproducible synthesis outcomes across varying dopant concentrations of x.

In an embodiment, the apparatus configuration employed during the combustion synthesis process is meticulously designed to promote thermal uniformity and reproducibility across multiple synthesis batches of NiPrₓFe₂₋ₓO₄ nanoparticles, particularly when varying the praseodymium dopant concentration x in the compositional range. Each combustion reaction is carried out within a 100 mL borosilicate glass beaker, selected for its high thermal shock resistance and chemical inertness toward nitrate-based precursor systems. To further insulate and stabilize the thermal environment during the highly exothermic combustion event, the outer surface of each beaker is tightly wrapped with a high-temperature ceramic fiber mat (alumina-silicate based, with a thermal tolerance >1100° C.), forming a protective thermal shell that moderates sudden heat loss to the surrounding atmosphere of the furnace.

The wrapped beakers are then placed symmetrically atop a circular alumina platform situated at the geometric center of the muffle furnace chamber. The alumina platform serves two key functions: it provides a thermally conductive yet chemically inert base that avoids contamination of the beaker contents, and it elevates the reaction vessels to a uniform height relative to the furnace heating elements. The beakers are arranged in a radial symmetry (typically 4-6 units placed equidistant from the center) to ensure that each combustion mixture experiences an identical thermal profile from the surrounding muffle environment.

This architectural configuration is not merely structural-it is fundamental to controlling the combustion kinetics and the spatial dynamics of the self-propagating reaction front. The ceramic insulation layer slows lateral heat dissipation, thus preventing premature cooling or edge-initiated quenching of the combustion wave, which could otherwise lead to inhomogeneous particle morphologies or incomplete phase conversion. Simultaneously, the equidistant layout within the furnace chamber ensures that the influence of thermal gradient asymmetries is minimized. Without such positional standardization, edge-located beakers would be exposed to lower or higher furnace wall temperatures than those placed centrally, leading to inter-batch variations in crystallinity, particle size, and defect concentration.

Empirical reproducibility studies demonstrate the efficacy of this configuration: when identical precursor-fuel formulations with x=0.0, 0.2, 0.4, and 0.6 are synthesized simultaneously using the described layout, the resulting NiPrₓFe₂₋ₓO₄ powders exhibit statistically indistinguishable XRD peak positions, FWHM values, and BET surface areas, with standard deviations of <2% across three batches. This uniformity is especially critical when conducting systematic studies on the effect of praseodymium doping concentration on the spinel lattice structure and electrochemical properties. Any uncontrolled variability in combustion thermal history would otherwise confound interpretation of structure-property relationships.

Moreover, combustion video analysis (recorded through a quartz viewport) reveals that the propagation front initiates at the center and expands radially in a nearly identical pattern across all beakers when the described apparatus arrangement is used. In contrast, control experiments performed without ceramic insulation or random beaker placement within the furnace exhibit significantly broader variance in reaction duration, peak flame intensity, and post-combustion texture of the resulting powder cake.

Thus, this embodiment introduces a hardware-level enhancement to the synthesis protocol, whereby the geometric symmetry, insulating configuration, and platform support synergistically ensure uniform thermal treatment of each reaction batch. This leads to enhanced batch-to-batch reproducibility, better control over phase evolution, and consistent nanostructural properties across varying values of dopant x, which are critical for material standardization and scalability of NiPrₓFe₂₋ₓO₄-based electrochemical devices.

In an embodiment, the mixing step in forming the slurry further comprises the incorporation of a non-ionic dispersing agent selected from the group consisting of polyvinylpyrrolidone (PVP) and polyethylene glycol (PEG), added at a concentration of 0.5-1.0 wt. % relative to the total slurry weight, wherein the dispersing agent adsorbs selectively on the NiPrₓFe₂₋ₓO₄ nanoparticle surfaces to inhibit flocculation and facilitate steric stabilization, thereby improving the slurry's homogeneity, shelf-life, and coating uniformity.

In an embodiment, the slurry preparation further refined by the strategic incorporation of a non-ionic dispersing agent selected from the group consisting of polyvinylpyrrolidone (PVP, molecular weight ~40,000) and polyethylene glycol (PEG, molecular weight ~6000), introduced into the system at a concentration ranging from 0.5 to 1.0 wt. % relative to the total mass of the slurry. This dispersing agent is added to the solvent-binder-active material mixture during the magnetic stirring phase, prior to mechanical homogenization. The purpose of this addition is to ensure optimal colloidal stability of the NiPrₓFe_{2-z}O₄ nanoparticles within the N-Methylpyrrolidone (NMP) medium and to prevent the formation of hard agglomerates that negatively affect film uniformity during electrode fabrication.

Mechanistically, the non-ionic dispersants function via steric stabilization. PVP and PEG molecules exhibit strong affinity for the surface of transition-metal oxide nanoparticles due to the presence of coordinating amide and ether functional groups, respectively. Upon adsorption, these polymer chains form a conformal coating around each nanoparticle, creating a physical barrier that prevents van der Waals-driven aggregation and bridging flocculation. The resulting repulsive steric forces maintain interparticle distances sufficient to inhibit clustering, even under elevated slurry concentrations and prolonged storage durations.

The addition of dispersants at this controlled concentration range is critical-concentrations below 0.5 wt. % may yield incomplete surface coverage, while excess dispersant (>1.0 wt. %) can introduce undesirable viscosity increases and phase separation in the slurry matrix. Rheological characterization via oscillatory shear tests demonstrates that the optimized dispersant-containing slurry exhibits a stable viscoelastic profile with reduced yield stress and improved thixotropic recovery. Furthermore, dynamic light scattering (DLS) and zeta potential measurements confirm the enhanced dispersion stability, showing a reduction in mean particle size distribution width (D90-D10) and a shift in Z-potential toward more negative values, consistent with surface adsorption and dispersion enhancement.

The inclusion of dispersants also significantly impacts the performance of the slurry during the doctor blade coating process onto current collector substrates (e.g., stainless steel or nickel foam). The treated slurries display improved wetting characteristics, as evidenced by lower contact angles and smoother film thickness profiles across the substrate. Scanning electron microscopy (SEM) images of the dried electrodes reveal a more uniform distribution of NiPrₓFe_{2-z}O₄ nanoparticles within the PVDF matrix, with fewer observable agglomerates and voids. This uniformity is essential for achieving high electrochemical activity and low internal resistance in supercapacitor applications.

Additionally, the presence of steric stabilizers enhances the shelf-life of the formulated slurry. Storage stability tests over 30 days at ambient conditions show no significant phase separation or sedimentation in dispersant-modified slurries, whereas control samples without dispersants exhibit visible settling and a substantial drop in usable viscosity after 10 days.

In an embodiment, the nickel foam substrate is pre-compacted using a uniaxial hydraulic press at a pressure of 1.5 MPa for 10 seconds to slightly reduce the pore diameter and increase the foam's mechanical density, thereby enabling better retention and infiltration of the active material during slurry deposition, while still maintaining sufficient open porosity to allow ionic diffusion during device operation.

In an embodiment, the nickel foam substrate is subjected to a pre-compaction treatment prior to slurry deposition, wherein the substrate is compressed using a uniaxial hydraulic press at a controlled pressure of approximately 1.5 MPa for a duration of 10 seconds. This mechanical densification step is performed at room temperature using a flat die set to apply uniform force distribution across the foam's surface area. The goal of this step is to slightly decrease the macropore diameter and increase the volumetric packing density of the metallic scaffold, thereby optimizing its microstructural suitability for hosting the active NiPrₓFe_{2-z}O₄ material.

The mechanical compaction reduces the average pore size without collapsing the open-cell structure, striking a critical balance between mechanical robustness and electrochemical accessibility. Scanning electron microscopy (SEM) and mercury intrusion porosimetry measurements conducted on pre-and post-compacted foams indicate a reduction in mean pore diameter from ~450 μm to ~380 μm, and a modest increase in foam density from ~0.35 g/cm³ to ~0.42 g/cm³. This densification improves the wettability of the nickel foam during slurry application, ensuring enhanced mechanical interlocking and capillary infiltration of the PVDF-bound nanoparticle slurry into the three-dimensional porous matrix.

As a result, the slurry shows increased retention within the foam's internal structure during the doctor-blade coating or drop-casting processes, leading to more uniform distribution of the active material and minimizing surface runoff or bridging defects. Moreover, the improved contact between the slurry and the current collector enhances the electrode's electronic conductivity by reducing interfacial resistance at the active material-substrate junction. The applied compaction pressure of 1.5 MPa is selected based on an optimization window that avoids excessive pore collapse or sintering of the metallic ligaments, thus preserving sufficient open porosity to facilitate ion transport during charge/discharge cycles. Electrochemical impedance spectroscopy (EIS) measurements of electrodes fabricated using compacted foams exhibit reduced charge-transfer resistance (R_ct) and enhanced Warburg diffusion characteristics, confirming that the ionic diffusion pathways remain intact.

Furthermore, mechanical adherence testing shows improved bonding strength between the coated layer and the substrate in compacted samples, thereby increasing resistance to delamination under repeated cycling or thermal fluctuation. The enhanced microstructural stability also contributes to improved cycle life and capacitance retention, as verified in long-term galvanostatic cycling tests.

In an embodiment, the active material slurry is applied to the nickel foam using a controlled drop-casting method coupled with localized heat-assisted spreading, wherein the substrate is maintained at 60° C. on a temperature-controlled hotplate during slurry deposition to reduce surface tension and accelerate solvent evaporation at the wetting front, thereby enabling more consistent layer formation, enhanced microstructural bonding between the ferrite layer and the metallic substrate, and suppression of cracking or delamination during the drying phase.

In an embodiment, the deposition of the active material slurry onto the nickel foam substrate is conducted using a precision drop-casting method integrated with localized thermal assistance, wherein the nickel foam is positioned on a temperature-controlled hotplate maintained at 60° C. throughout the slurry application process. This approach is designed to modulate the wetting dynamics, solvent evaporation kinetics, and interfacial bonding behavior during deposition of the NiPrₓFe₂₋ₓO₄-PVDF-based slurry onto the porous metallic substrate.

During the process, the slurry-prepared as per the previous embodiments with homogenized nanoparticle dispersion and optimized rheology-is incrementally dispensed drop-wise using a calibrated micropipette or automated dispenser system. As the slurry contacts the pre-heated nickel foam, the elevated substrate temperature reduces the surface tension of the N-Methylpyrrolidone (NMP) solvent at the solid-liquid interface. This results in enhanced capillary infiltration into the micro-and meso-porous structure of the foam, thereby promoting deep penetration and minimizing surface accumulation or over-thickened regions.

Simultaneously, the moderate heat at 60°° C. accelerates localized solvent evaporation specifically at the wetting front, which contributes to the formation of a consolidated and well-adhered ferrite layer with minimal pooling or agglomeration. The controlled evaporation also suppresses Marangoni flow-induced segregation, a common issue in ambient-temperature drop-casting that leads to inhomogeneous surface morphology and binder migration.

The heat-assisted method further facilitates thermally activated chain mobility within the PVDF binder, promoting better wrapping of the polymer matrix around the NiPrₓFe₂₋ₓO₄ nanoparticles and enabling strong microstructural bonding at the ferrite-metal interface. As a result, upon completion of the deposition and subsequent full drying, the electrode layer exhibits high mechanical integrity, with minimal instances of cracking, delamination, or edge curling-defects that are typically associated with uneven solvent loss or shrinkage stress during drying.

Post-deposition scanning electron microscopy (SEM) analysis of cross-sections reveals a dense, crack-free ferrite coating with uniform thickness across the nickel foam ligaments, while adhesion strength measurements using peel testing demonstrate an increase of up to 40% in cohesive bonding relative to samples fabricated via unheated drop-casting. Electrochemical characterization of such thermally-assisted drop-cast electrodes shows enhanced cycling stability and lower series resistance (Rs), attributed to improved interfacial contact and structural cohesion. This embodiment implements a thermally regulated drop-casting strategy that synergistically combines heat-induced solvent management with enhanced wetting behavior to achieve superior coating uniformity, robust electrode integrity, and optimized electrochemical performance for high-efficiency supercapacitor applications.

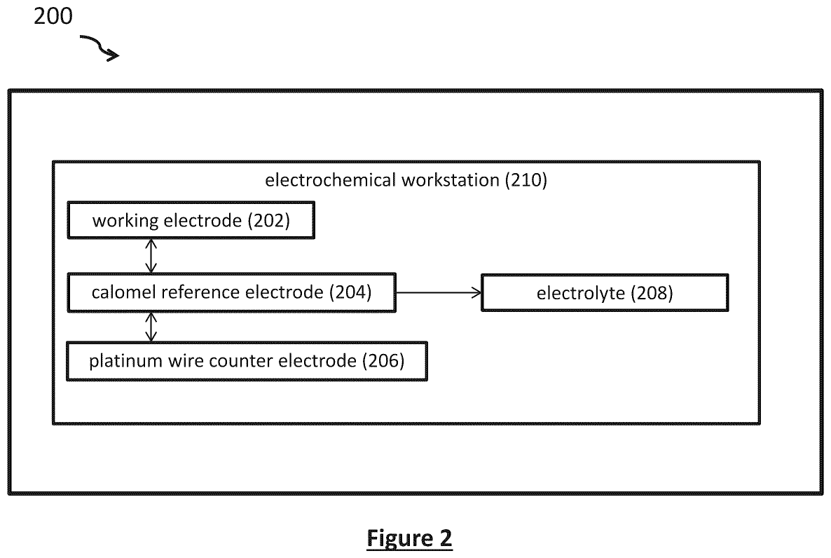

FIG. 2 illustrates a block diagram of a three-electrode electrochemical device (200) for evaluating supercapacitor materials, in accordance with an embodiment of the present disclosure.

Referring to FIG. 2, the device (200) comprises: a working electrode (202) comprising a nickel foam current collector coated with a dried slurry containing 90 wt % active material of NiPrₓFe₂₋ₓO_{4, 5} wt % polyvinylidene fluoride (PVDF) as a binder, and 5 wt % carbon black as a conducting material; a calomel reference electrode (204) positioned in electrical contact with the electrolyte; a platinum wire counter electrode (206); an electrolyte (208) comprising 3M aqueous potassium hydroxide (KOH) solution; and an electrochemical workstation (210) equipped with a frequency response analyzer (FRA), configured to perform cyclic voltammetry, galvanostatic charge-discharge, and electrochemical impedance measurements.

In an embodiment, the electrode is formed using material selected from NiPrₓFe₂₋ₓO₄ with x equal to 0.000, 0.005, 0.010, 0.015, or 0.020.

In embodiment, the working electrode area is approximately 1 cm×1 cm, wherein the electrochemical workstation is configured to apply a CV scan in the range of −1.0 V to 0 V, and perform impedance spectroscopy in the frequency range of 100 kHz to 0.01 Hz.

The present invention relates to synthesis of praseodymium-doped nickel ferrite nanoparticles for supercapacitor applications, wherein the synthesis is carried out using a solution combustion technique, with praseodymium doping concentration varying from 0 to 0.02. The present invention further aims to evaluate the effects of incorporation of Pr⁺³ on the structural, magnetic, and electrical properties of the nickel ferrite nanoparticles, and assess their potential for usage in emerging technology applications. The prepared praseodymium doped ferrite nanoparticles are subjected to supercapacitor studies in a three-electrode system. Techniques such as cyclic voltammetry, galvanostatic charge-discharge, and electrochemical impedance spectroscopy were employed to investigate the electrochemical performance and identify the optimal Pr-doping concentration for enhanced supercapacitor performance.

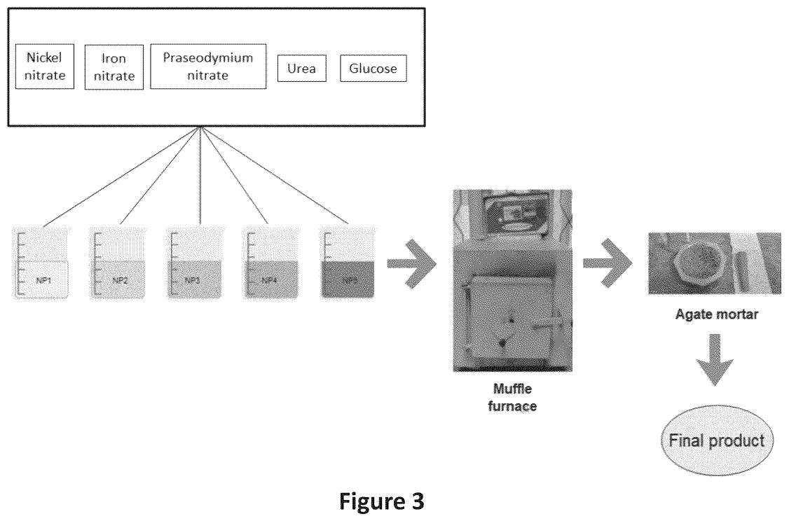

FIG. 3 illustrates a schematic diagram representing the preparation of nanoparticles, in accordance with an embodiment of the present disclosure.

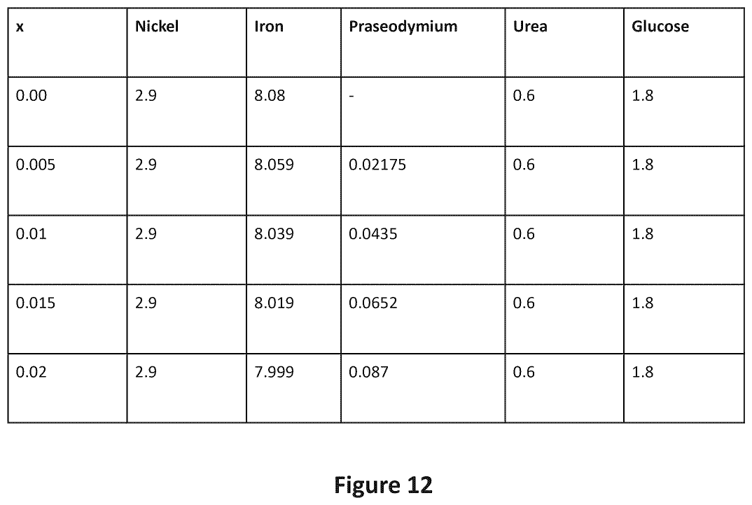

Referring to FIG. 3, the Pr³⁺ doped nickel ferrite nanoparticles are prepared using solution combustion technique with the general formula NiPrₓFe₍₂₋ₓ₎O₄, where x varies from 0.00, 0.005, 0.01, 0.015, 0.02. The oxidiser and fuel were taken in a ratio of 1:1, namely Iron (Fe(NO₃)₂·9H₂O), nickel (Ni(NO₃)₂·6H₂O), praseodymium (Pr(NO₃)₂·6H₂O) and Urea (CO(NH₂)₂), Glucose (C₆H₁₂O₆) respectively. The concentration of iron and praseodymium fluctuates whereas that of nickel remains constant. In five different beakers the precursors were taken in the stoichiometric concentration as in Table in FIG. 12, as shown under. The precursors were then dissolved using 30 ml of distilled water. Once dissolved the beakers were kept in preheated (450° C.) Muffle furnace for about 30 minutes. During the combustion of the nitrates, glucose and urea serve as fuels. The obtained product was crushed using agate mortar and hydraulic press was used to create pellets. Further the pellets were used for additional supercapacitor application.

A three-electrode system is used for performing electrochemical analysis of all the prepared ferrites nanoparticles, wherein the three-electrode system is used with active material coated nickel foam as the working electrode, calomel electrode as the reference and platinum wire as the counter electrode in 3M KOH electrolyte solution. The working electrode was prepared by coating slurry of active mass in a 1 cm×1 cm area. The slurry was prepared with 90% active material (NiPrₓFe₍₂₋ₓ₎O₄ where x=0.00, 0.005, 0.01, 0.015, 0.02), 5% polyvinylidene fluoride (PVDF) as binder and 5% carbon black as conducting material in N-Methylpyrrolidone (NMP) as solvent. The homogeneous slurry was coated and then kept for drying in 50° C. in the oven overnight. The prepared working electrode was then taken up for electrochemical investigation with the help of Metrochem AUTOLAB M302 instrument with inbuilt frequency response analyzer (FRA). Cyclic voltammetry experiments were performed over a potential range of −1.0V to OV, with different scan rates ranging from 5 mVs⁻¹ to 100 mVs⁻¹. Constant current Galvanostatic charge-discharge studies were conducted with various current densities, ranging from 0.25 Ag-1 to 1.0 Ag-1. The impedance analyses are studied across frequency range 100k kHz to 0.01 Hz, with a 10 mV AC amplitude signal at the open circuit potential (OCP). The specific capacitance was calculated from the GCD curve for three-electrode system using the formula;

$${C}_{sp} = \frac{I \times Δ t}{m \times Δ V} \qquad ( 1 )$$

where I represents the input current, Δt is the discharge time in seconds, m is the active mass loaded in the working electrode and ΔV is the operating potential window.

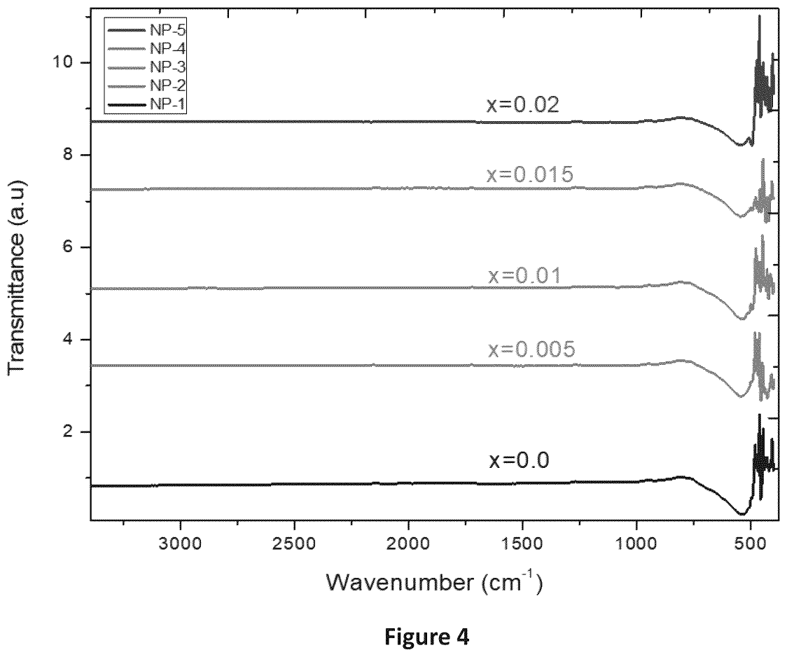

FIG. 4 illustrates a graphical representation of FTIR Plot of NiPrₓFe₂₋ₓO₄ (x=0.0,0.005,0.01,0.015,0.02), in accordance with an embodiment of the present disclosure.

Referring to FIG. 4, the Fourier Transform Infrared (FTIR) spectra of NiPrₓFe₂₋ₓO₄ at various concentration of x (0.0,0.005,0.01,0.015,0.02) is recorded in the range of 300 to 3500 cm⁻¹. The recognised range for ferrites is usually between 400 to 4000 cm⁻¹.

From the FTIR spectra, a shift is observed in the peak as the concentration of Pr⁺³ varied. The obtained peaks were randomised occurring mainly between 400 to 500 cm⁻¹. It is observed that the high frequency band v₁ and low frequency band v₂ showed random increase and decrease variation with change in the concentration of Pr⁺³, this might be due to the change in ionic radius of Pr⁺³ and Fe⁺³. The Pr⁺³ ions replace the Fe⁺² ions from the A and B sites irregularly which affects the Fe⁺³—O⁻ stretching resulting in the decrease of octahedral vibrational frequency and increase in the concentration of Fe⁺³ at the A sites results in the increase of the tetrahedral vibrational frequency. All our samples showed random splitting of octahedral and tetrahedral.

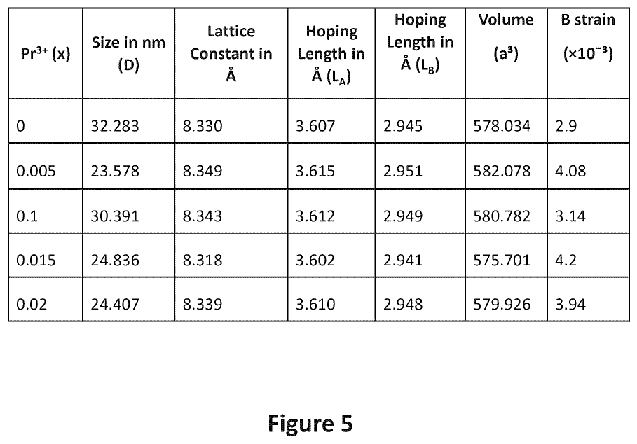

FIG. 5 illustrates a table representing Size, Lattice Constant, Hoping Length of NiPrFeO₄ with doping at 0,0.005,0.01,0.015,0.02, in accordance with an embodiment of the present disclosure.

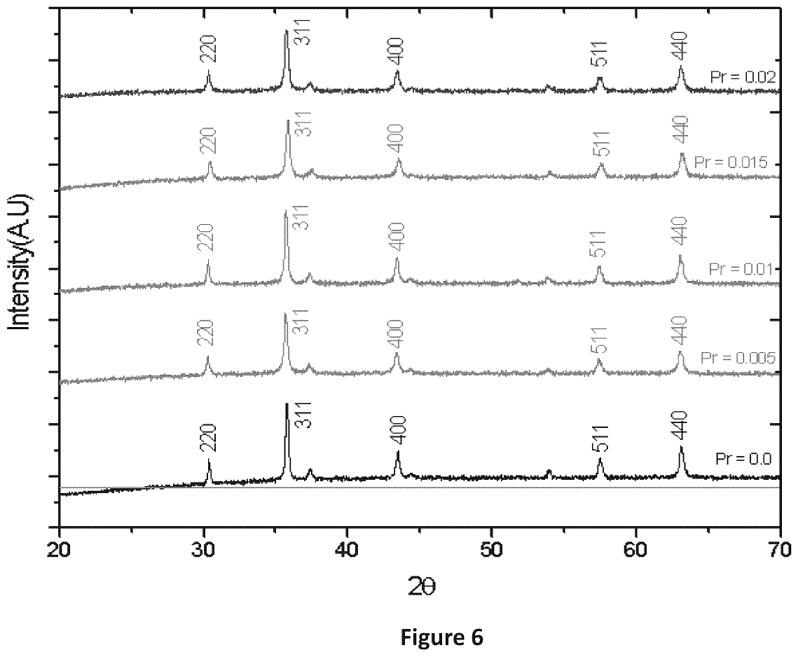

FIG. 6 illustrates an XRD Plot of NiPrₓFe_{2-z}O₄ (x=0.0,0.005,0.01,0.015,0.02), in accordance with an embodiment of the present disclosure.

All the prepared samples were subjected to characterise X-ray diffractogram (XRD) to confirm the phase, crystallinity and structure formation.

The XRD patterns of Ni ferrite and Pr³⁺ doped Ni²⁺ ferrites with general formula of NiPrₓFe₂₋ₓO₄, where x is equals to 0.0, 0.005, 0.01, 0.015, 0.02, is illustrated in FIG. 6. XRD pattern of all the samples exhibits spinel cubic structure with single phase along with FCC. The Debye-Scherrer method measures the crystalline size by peak broadening analysis. The equation (2) given below, enables the determination of the average crystalline size using full width at half maximum (FWHM) value at highest peak.

$$DD - S = \frac{k λ}{{β}_{D} cos cos θ} nm \qquad ( 2 )$$

The calculated size of the crystal was found between 23.578 to 32.283 nm exhibiting a random behaviour, this might be due to inconsistent stress induced on the samples during preparation. The obtained lattice parameters are random, this might be due to the concentration of rare earth cation ‘Pr³⁺’ is large and has a large ionic radius when compared to Fe, therefore the structure transformed from spinel to singe phase FCC spinel structure.

Crystalline imperfections, distortions, and misalignments in the lattice lead to lattice strain in the powder sample, which can be described using the Stokes and Wilson relation, as shown in equation (3) given below.

$$ε = \frac{{β}_{strain}}{4 tan tan θ} \qquad ( 3 )$$

The lattice constant results of samples prepared are random varying from 8.318 to 8.349 Å as mentioned, as described in the Table, as show in FIG. 5. The varying concentration of Pr³⁺ dopant has influence over the unit cell volume, which gives the outcome of the relation of Pr³⁺ concentration over unit cell volume.

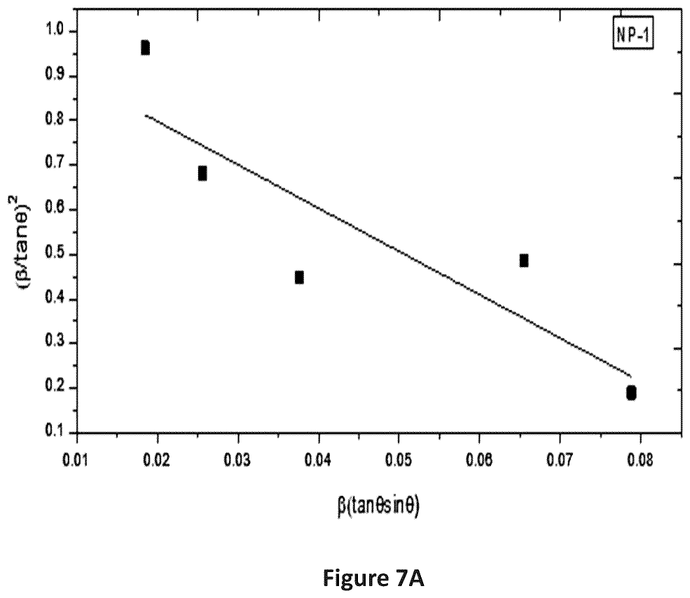

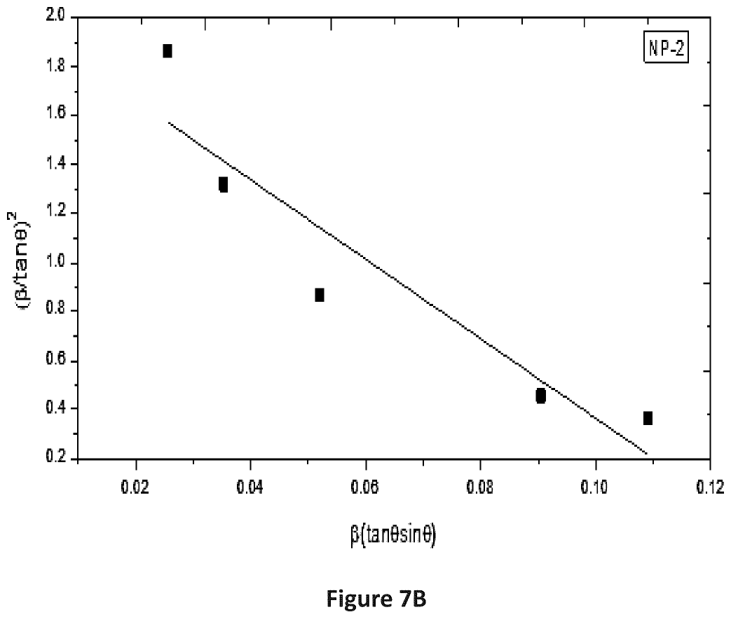

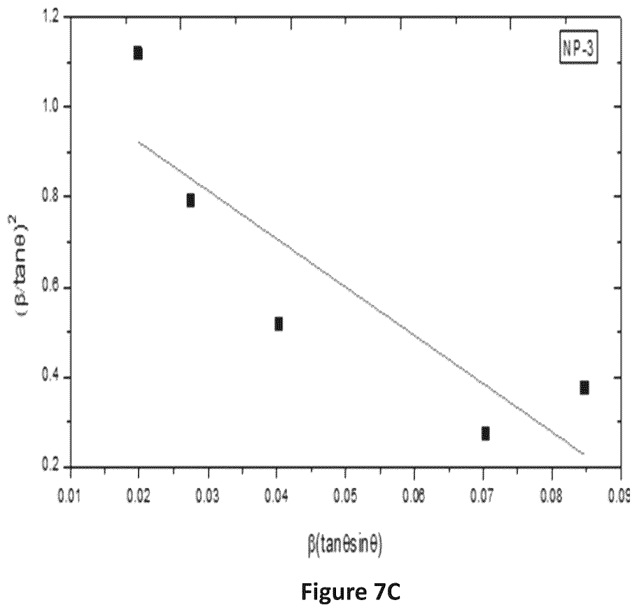

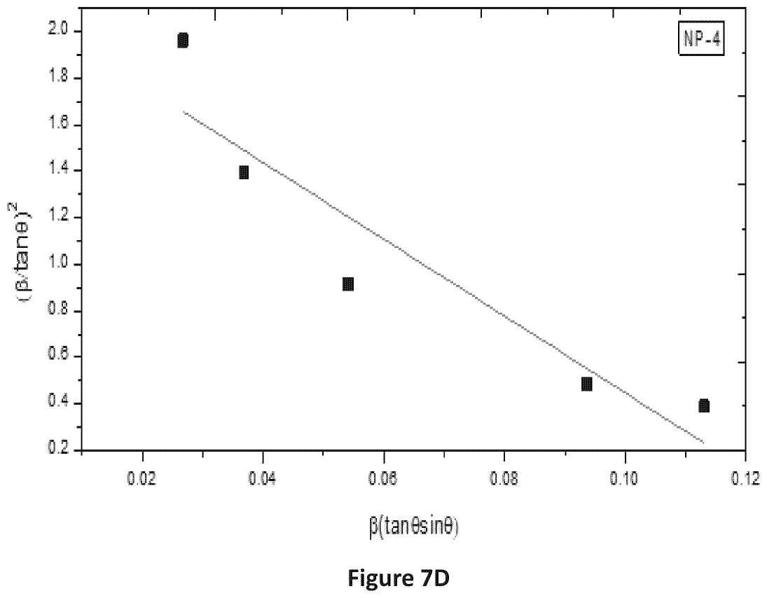

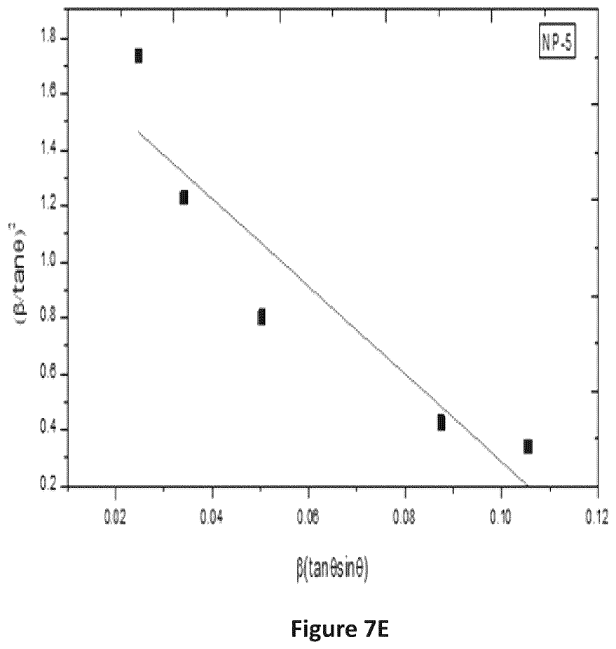

FIG. 7A illustrates a H-W plot of NiPrₓFe₂₋ₓO₄ at x=0.0, in accordance with an embodiment of the present disclosure

FIG. 7B illustrates a H-W plot of NiPrₓFe_{2-z}O₄ at x=0.005, in accordance with an embodiment of the present disclosure.

FIG. 7C illustrates H-W plot of NiPrₓFe₂₋ₓO₄ at x=0.01, in accordance with an embodiment of the present disclosure.

FIG. 7D illustrates H-W plot of NiPrₓFe₂₋ₓO₄ at x=0.015, in accordance with an embodiment of the present disclosure.

FIG. 7E illustrates H-W plot of NiPrₓFe₂₋ₓO₄ at x=0.02, in accordance with an embodiment of the present disclosure.

Referring to FIG. 7A, 7B, 7C, 7D, and 7E, the H-W plot is drawn with β (tanθsinθ) along the x axis and (β/tanθ)² along the y axis for the prepared Ni⁺² ferrite sample.

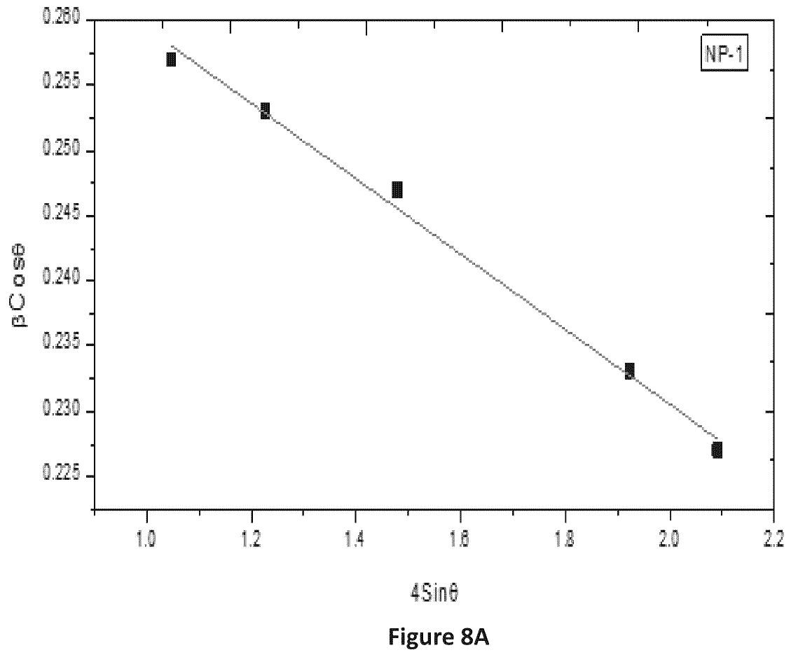

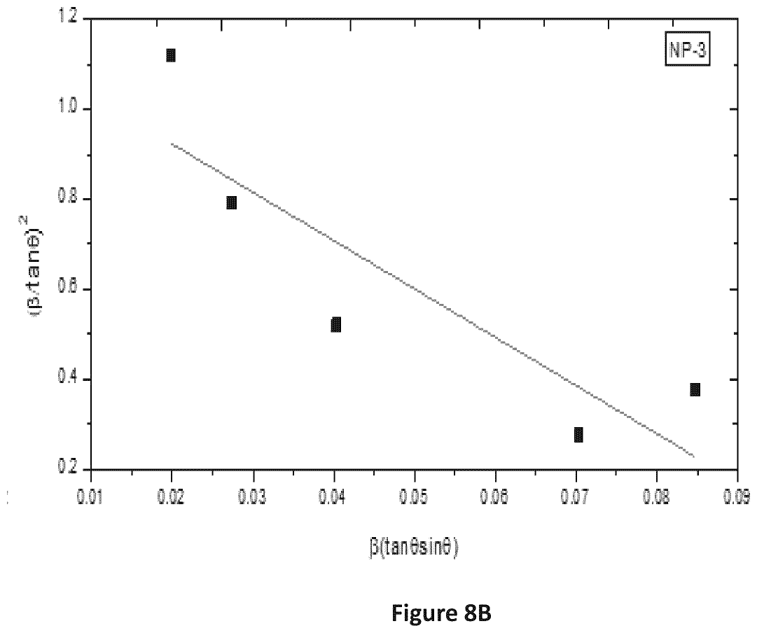

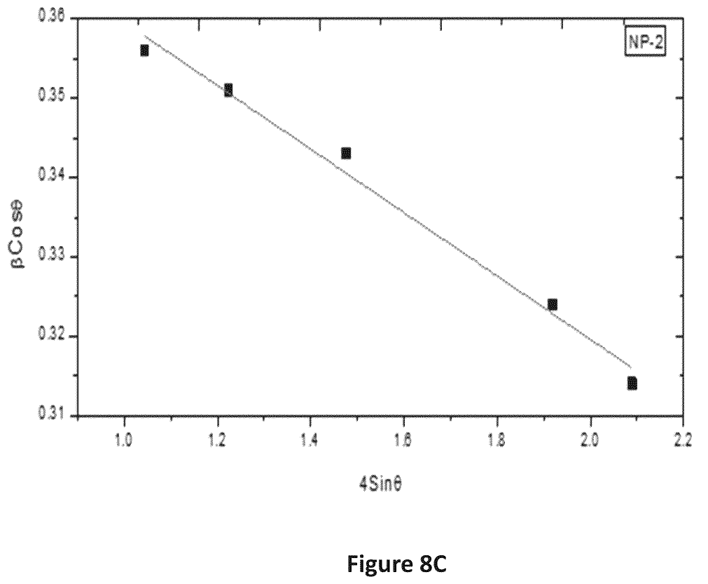

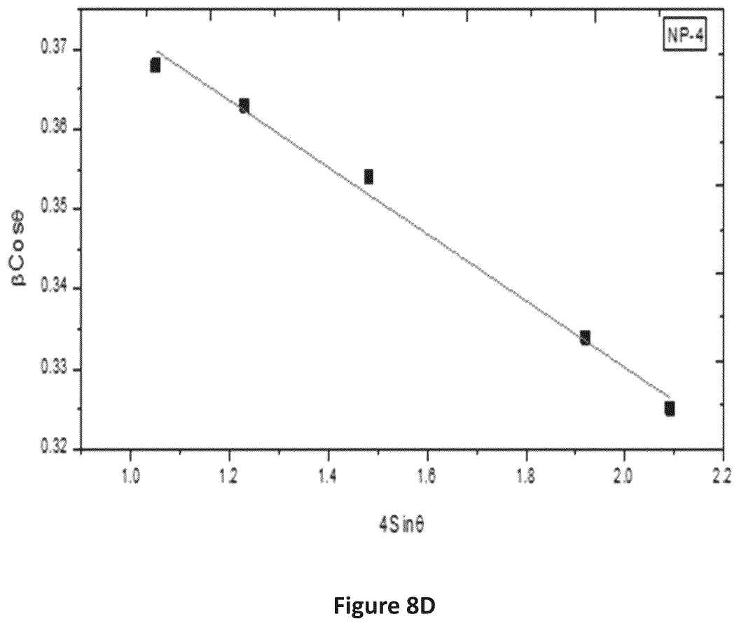

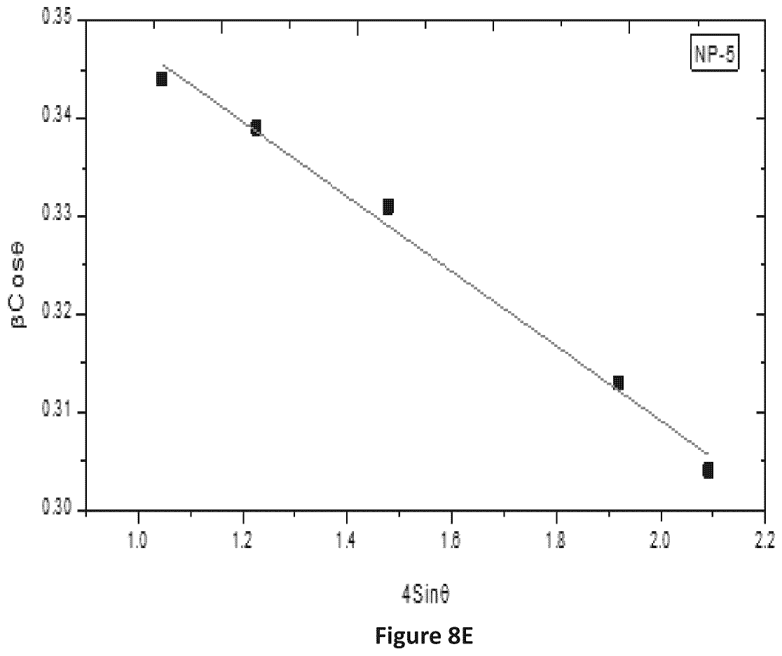

FIG. 8A illustrates W-H plots of NiPrₓFe_{2-z}O₄ at x=0.00, in accordance with an embodiment of the present disclosure.

FIG. 8B illustrates W-H plots of NiPrₓFe₂₋ₓO₄ at x=0.005, in accordance with an embodiment of the present disclosure.

FIG. 8C illustrates W-H plots of NiPrₓFe₂₋ₓO₄ at x=0.01, in accordance with an embodiment of the present disclosure.

FIG. 8D illustrates W-H plots of NiPrₓFe₂₋ₓO₄ at x=0.015, in accordance with an embodiment of the present disclosure.

FIG. 8E illustrates W-H plots of NiPrₓFe₂₋ₓO₄ at x=0.02, in accordance with an embodiment of the present disclosure.

Referring to FIG. 8A, 8B, 8C, 8D, and 8E, for preparing the W-H plot, using the Williamson-Hall method, Size broadening and strain broadening must be combined. By examining the peak breadth, the Williamson and Hall method, the simplest integral breadth technique, distinguishes between strain-dependent line broadening and crystallite size. The plot is drawn with 4sin along the x axis and βcos along the y axis for the prepared Ni⁺² ferrite sample. The strain was calculated from the slope of the fit, and the crystalline size was determined from the y-intercept of the linear fit to the data.

The Stokes-Wilson relation can show the peak broadening caused by the lattice strain.

$${β}_{strain} = 4 ε tan tan θ \qquad ( 4 )$$

The Williamson-Hall equation resembles the equation of straight line, y=mx+c.

The Lattice constant showed random behaviour with respect to the dopant concentration. The temperature difference and concentration variation induced the random behaviour of Lattice Parameters. FIG. 7 depicts the randomness of lattice contact with respect to the Praseodymium concentration.

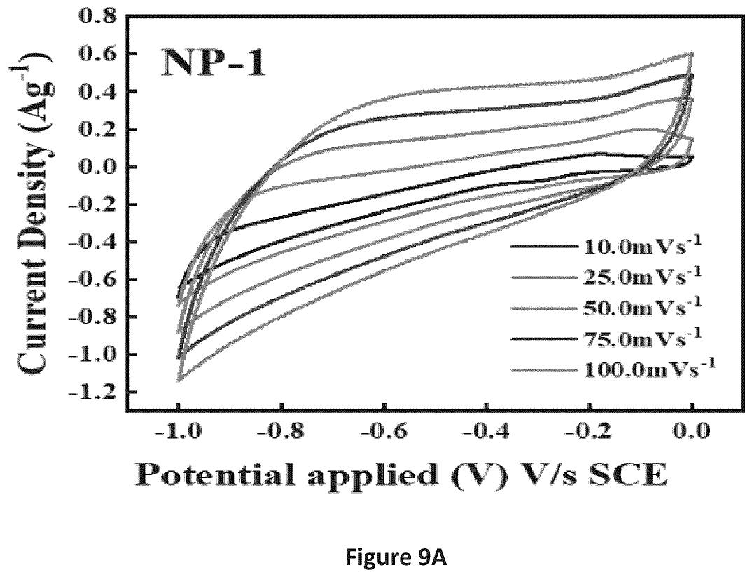

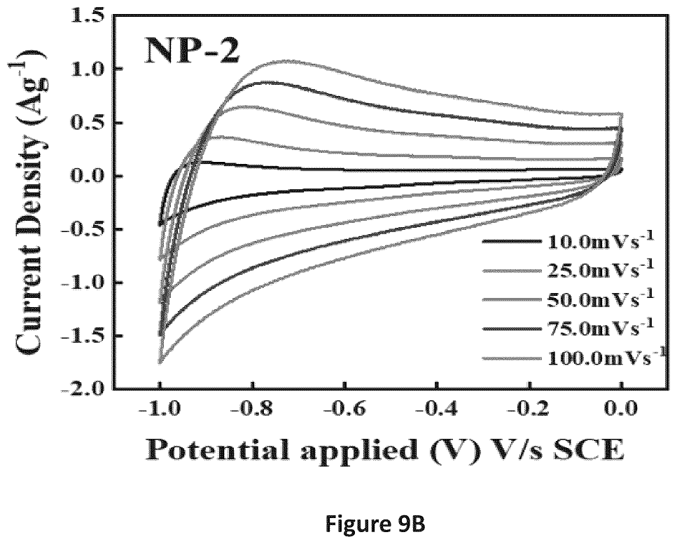

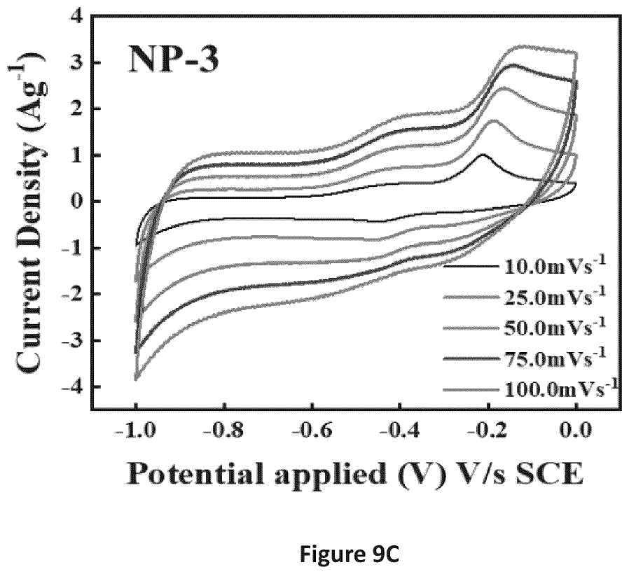

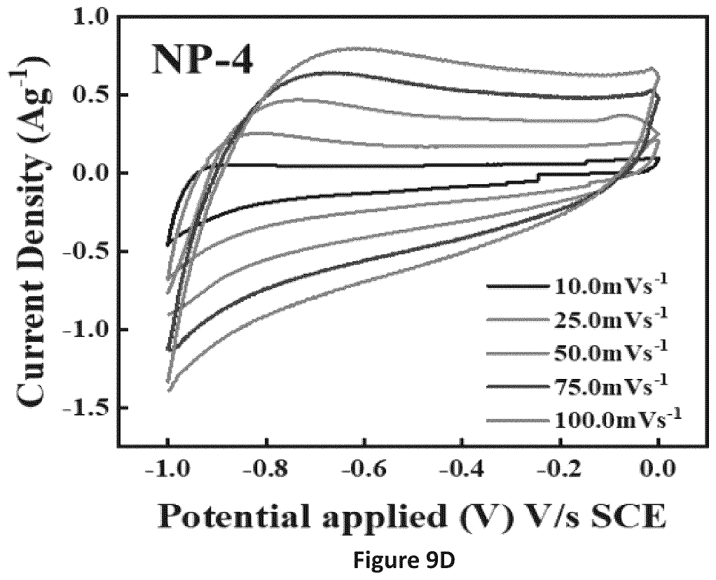

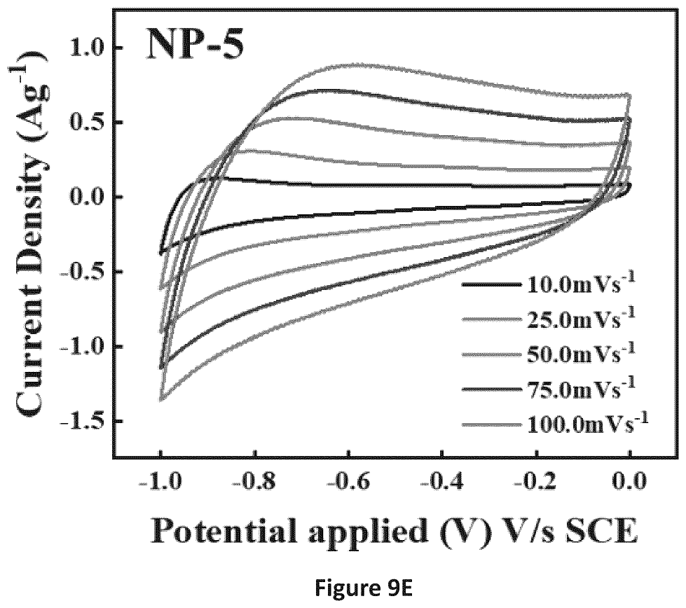

FIG. 9A illustrates CV characteristics of NiPrₓFe_{2-z}O₄ at x=0.00, in accordance with an embodiment of the present disclosure.

FIG. 9B illustrates CV characteristics of NiPrₓFe₂₋ₓO₄ at x=0.005, in accordance with an embodiment of the present disclosure.

FIG. 9C illustrates CV characteristics of NiPrₓFe_{2-z}O₄ at x=0.01, in accordance with an embodiment of the present disclosure.

FIG. 9D illustrates CV characteristics of NiPrₓFe₂₋ₓO₄ at x=0.015, in accordance with an embodiment of the present disclosure.

FIG. 9E illustrates CV characteristics of NiPrₓFe₂₋ₓO₄ at x=0.02, in accordance with an embodiment of the present disclosure.

Referring to FIG. 9A, 9B, 9C, 9D, and 9E, the electrochemical performance of the sample NP-1, NP-2, NP-3, NP-4 and NP-5 were studied in a three-electrode system in 3M KOH solution, wherein CV plots of the material is illustrated at various scan rates ranging from 10-100 mVs⁻¹.

It can be seen from the graphs shown in FIG. 9, the CV profiles of all the materials exhibit a quasi-rectangular shape with distinct redox peaks, indicating a combination of electric double-layer capacitance and pseudocapacitance. The redox peaks are due to the reversible redox reactions of Ni²⁺/Ni³⁺ and Fe³⁺/Fe²⁺ as follows;

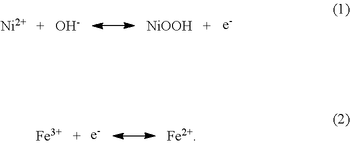

As the scan rate increases, the current density rises, and the redox peaks shift slightly towards higher potentials, demonstrating good charge transport. The increase in area with scan rates reflects enhanced capacitive behaviour and fast ion-diffusion. The symmetry in the CV anodic and cathodic branches highlights stable and reversible electrochemical performances. Praseodymium doping further improves the conductivity and introduces additional active sites, enhancing the overall charge storage capability of the material, making it promising for supercapacitor applications.

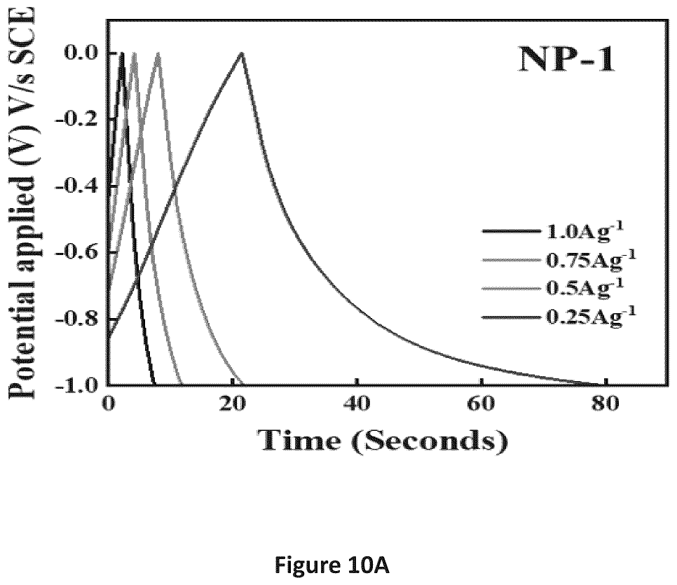

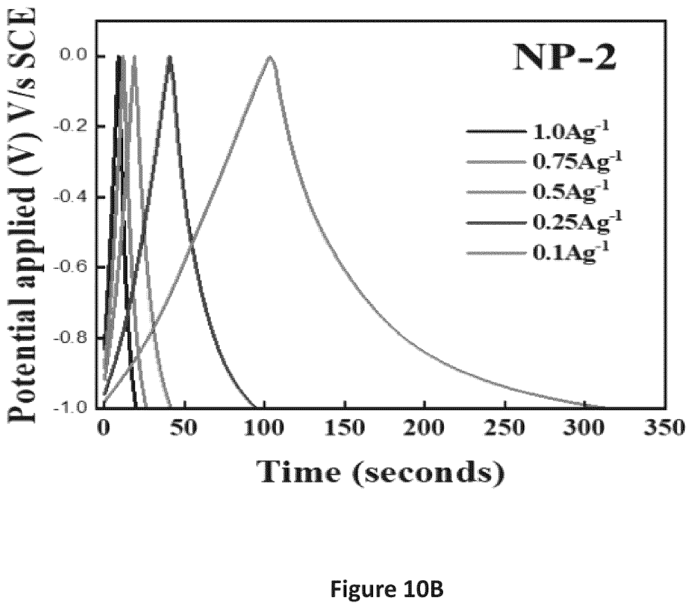

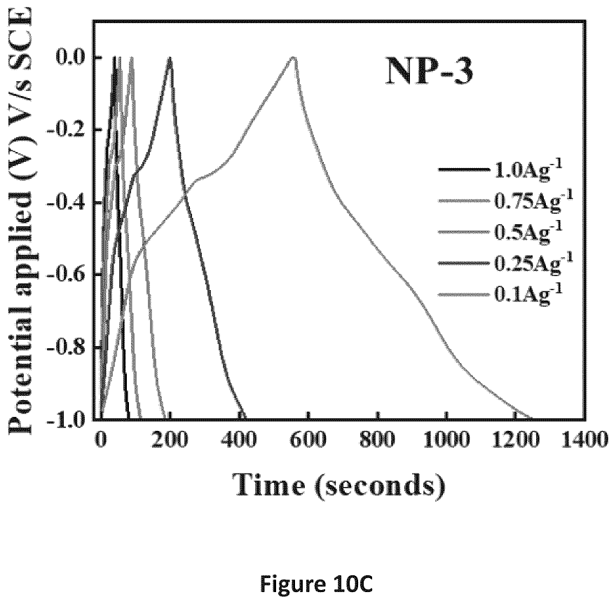

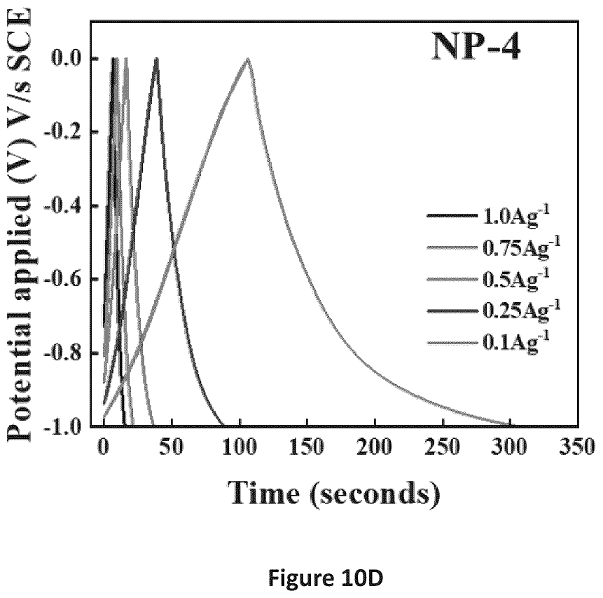

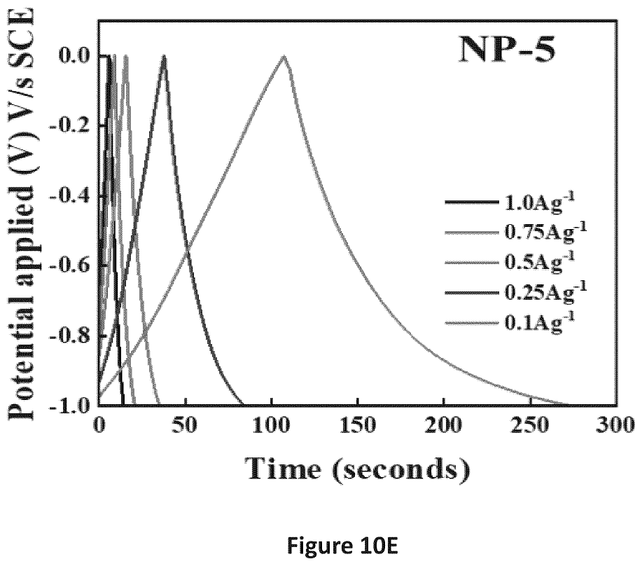

FIG. 10A illustrates Galvanostatic charge-discharge characteristics of NiPrₓFe₂₋ₓO₄ at x=0.0, as NP-1, in accordance with an embodiment of the present disclosure.

FIG. 10B illustrates Galvanostatic charge-discharge characteristics of NiPrₓFe₂₋ₓO₄ at x=0.005, as NP-2, in accordance with an embodiment of the present disclosure.

FIG. 10C illustrates Galvanostatic charge-discharge characteristics of NiPrₓFe₂₋ₓO₄ at x=0.01, as NP-3, in accordance with an embodiment of the present disclosure.

FIG. 10D illustrates Galvanostatic charge-discharge characteristics of NiPrₓFe₂₋ₓO₄ at x=0.015, as NP-4, in accordance with an embodiment of the present disclosure.

FIG. 10E illustrates Galvanostatic charge-discharge characteristics of NiPrₓFe₂₋ₓO₄ at x=0.02, as NP-5, in accordance with an embodiment of the present disclosure.

Referring to FIG. 10A, 10B, 10C, 10D, and 10E, from the galvanostatic charge-discharge (GCD) curves of Praseodymium-doped nickel ferrites NiPrₓFe₂₋ₓ (NP-1, NP-2, NP-3, NP-4 and NP-5), it is found out that, all the GCD curves exhibited triangular shape curve characteristics of the EDLC with slight variation indicating the pseudocapacitance nature. The maximum value for specific capacitance was calculated from the GCD curve and found to be 14.25, 13.0,54.75, 12.0, and 11.25Fg⁻¹ at current density of 0.25Ag⁻¹ for NP-1, NP-2, NP-3, NP-4 and NP-5 respectively. Among the various ferrites NP-3 was able to exhibit highest specific capacitance of 69.2Fg⁻¹ at lower current density of 0.1Ag⁻¹. NP-3 was able to achieve this performance due to optimal Praseodymium doping, which introduces the additional active sites, enhanced conductivity and maintains the structural integrity. This balance improves the charge storage and transfer kinetics, leading to longer-charge-discharge times and higher energy storage efficiency compared to the other ferrites. Excessive doping (as seen in case of NP-4 and NP-5) likely causes lattice distortion or particle aggregation, reducing the material conductivity and overall electrochemical performance. Moreover, the enhanced redox activity of Ni²⁺/Ni³⁺ and Fe³⁺/Fe²⁺ transitions in NP-3 is significantly contributed by the pseudocapacitance behaviour. Thus, NP-3 delivers reliable energy storage and fast charge-discharge capabilities making them suitable for energy storage devices.

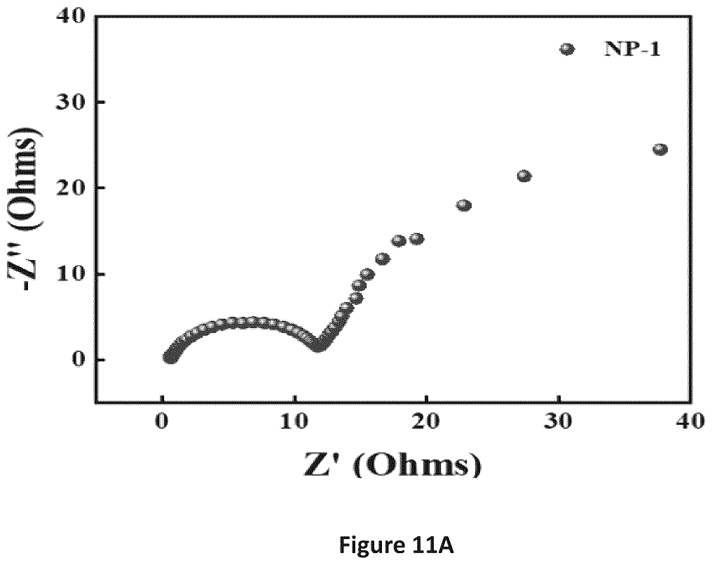

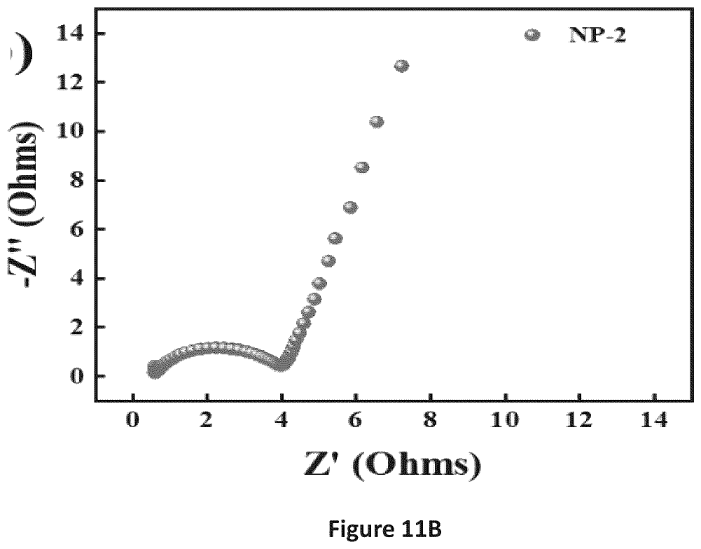

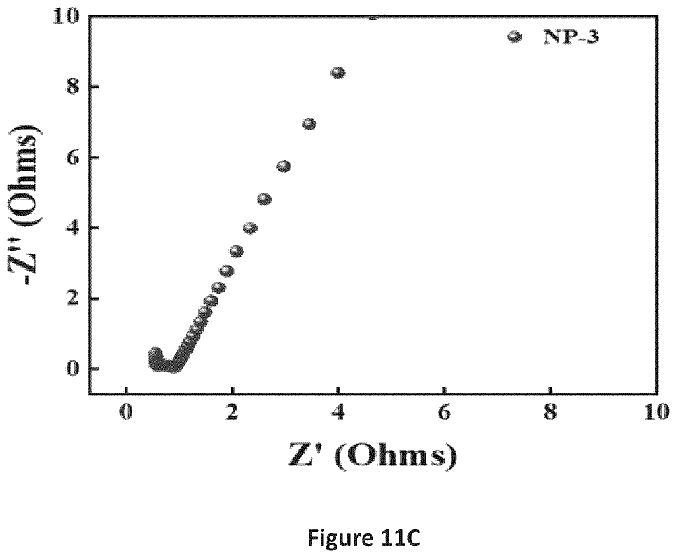

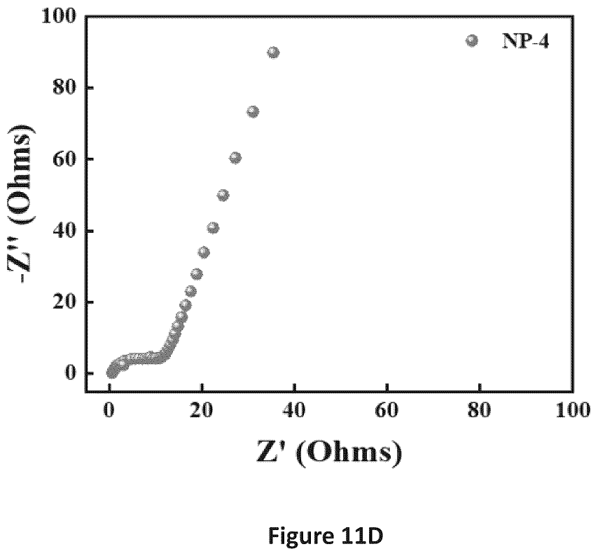

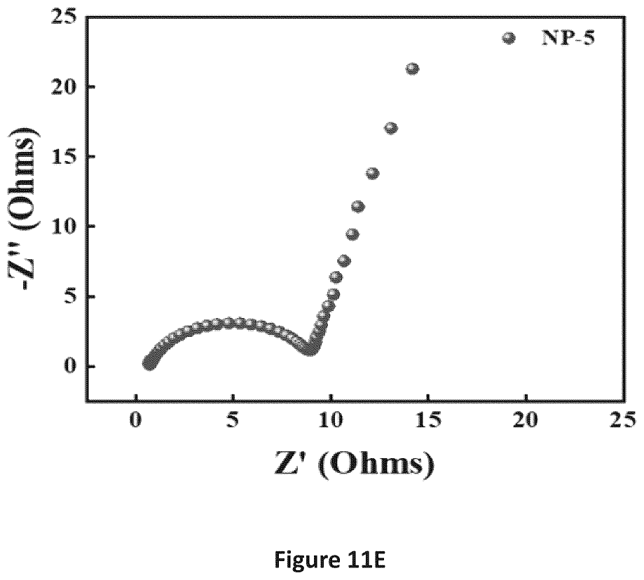

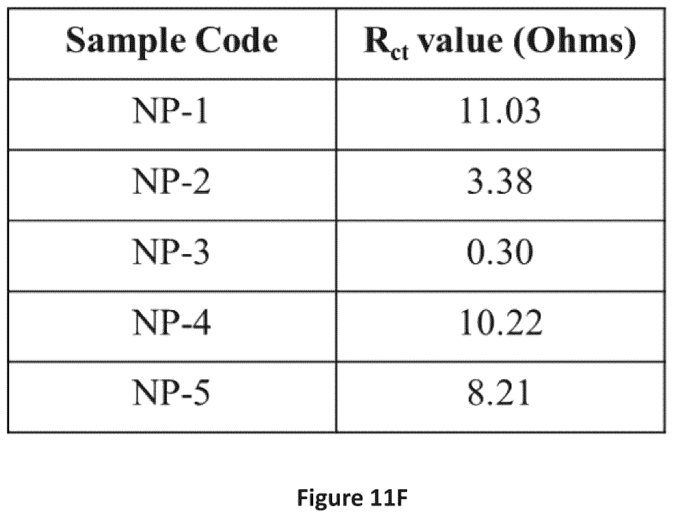

FIG. 11A illustrates Nyquist plot of NiPrₓFe_{2-z}O₄ at x =0.0, as NP-1, in accordance with an embodiment of the present disclosure.

FIG. 11B illustrates Nyquist plot of NiPrₓFe₂₋ₓO₄ at x=0.005, as NP-1, in accordance with an embodiment of the present disclosure.

FIG. 11C illustrates Nyquist plot of NiPrₓFe₂₋ₓO₄ at x=0.01, as NP-1, in accordance with an embodiment of the present disclosure.

FIG. 11D illustrates Nyquist plot of NiPrₓFe₂₋ₓO₄ at x=0.015, as NP-1, in accordance with an embodiment of the present disclosure.

FIG. 11E illustrates Nyquist plot of NiPrₓFe₂₋ₓO₄ at x=0.02, as NP-1, in accordance with an embodiment of the present disclosure.

FIG. 11F illustrates a table representing the Rct values of the ferrites, in accordance with an embodiment of the present disclosure.

Referring to FIG. 11A, 11B, 11C, 11D, and 11E, the frequency response of the synthesized ferrites are studied with the help of electrochemical impedance spectroscopy (EIS) experiments. The Nyquist plot of each ferrite displays a semicircle in the high-frequency region, indicative of bulk resistance, followed by a 45° straight slope line in the lower frequency indicative of the warburg impedance, suggesting diffusion-limited processes or surface reactions. Referring to FIG. 11F, from the analysis of the Nyquist plots, the charge transfer resistance (Rat) values were found to be 11.0322, 3.3852, 0.3052, 10.2252 and 8.2192 for NP-1, NP-2, NP-3, NP-4 and NP-5 respectively. The NP-3 exhibits the lowest Rct value of 0.3052. This low Rct value is highly desirable for supercapacitor applications, as it indicates a faster rate of charge transfer at the electrode-electrolyte interface. This also explains the high specific capacitance value shown by NP-3, when compared to all other ferrites. A lower Rct value also facilitates the rapid electron transfer and ion diffusion within the electrode material, leading to improved electrochemical performance which is crucial for high-performance supercapacitors.

The present invention relates to the synthesis and characterization of praseodymium-doped nickel ferrite (NiPrₓFe₂₋ₓO₄) nanoparticles, using the solution combustion method, and the structural, morphological, and electrochemical properties of the prepared nanoparticles are thoroughly analysed.

The X-ray diffraction (XRD) analysis confirmed the formation of a spinel cubic structure with single-phase FCC across all samples. The introduction of Pr³⁺ into the ferrite lattice led to slight variations in crystallite size and lattice parameters, with a random behavior observed due to inconsistent stress induced during preparation. Optimal doping of Pr³⁺ improved the structural integrity without significantly disrupting the spinel structure. The Williamson-Hall (W-H) plot further indicated that the samples exhibited minimal strain, particularly with optimal Pr doping.

Fourier-transform infrared spectroscopy (FTIR) revealed that the characteristic ferrite peaks appeared between 400 and 500 cm⁻¹, with random shifts in the high-and low-frequency bands as Pr³⁺ concentration increased. This can be attributed to the replacement of Fe³⁺ ions by Pr³⁺, which caused changes in ionic radii, impacting the vibrational frequencies of the octahedral and tetrahedral sites. The random splitting of these frequencies indicates that the Pr³⁺ ions irregularly replace Fe²⁺ ions, thus impacting the material's overall structure.

The electrochemical analysis, conducted via cyclic voltammetry (CV), galvanostatic charge-discharge (GCD), and electrochemical impedance spectroscopy (EIS), demonstrated that Pr-doping improved the material's charge storage capacity and conductivity. Among all the samples, the NP-3 composition (with 0.01 Pr-doping) exhibited the highest specific capacitance of 69.2 F/g at a current density of 0.1 A/g and the lowest charge transfer resistance (Rct) of 0.30 Ω. These results suggest that optimal Pr-doping introduces additional active sites and enhances the conductivity, making NP-3 an excellent candidate for high-performance supercapacitor applications.

Praseodymium-doped nickel ferrites, particularly NP-3, show great promise for energy storage devices due to their superior electrochemical performance. The combination of structural stability, high capacitance, and low charge transfer resistance highlights the potential of Pr-doped ferrites for next-generation supercapacitors.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A process for fabricating an electrochemical device for high-performance supercapacitor applications, comprising:
a) preparing a plurality of aqueous precursor solutions using stoichiometric ratios of metal nitrates selected from iron nitrate (Fe(NO₃)₃·9H₂O), nickel nitrate (Ni(NO₃)₂·6H₂O), and praseodymium nitrate (Pr(NO₃)₃·6H₂O), wherein the praseodymium dopant concentration x is varied from 0.000 to 0.020, and the concentration of nickel is kept constant;
b) dissolving the said plurality of aqueous precursors in distilled water in respective beakers to form homogeneous solutions;
c) adding a 1:1 ratio of oxidizers and fuels to each solution, wherein the fuels comprise urea (CO(NH₂)₂) and glucose (C₆H₁₂O₆);
d) placing the beakers containing the precursor-fuel mixtures into a preheated muffle furnace at approximately 450° C. for a duration of about 30 minutes to initiate solution combustion synthesis, thereby forming a solid ferrite product;
e) cooling and crushing the obtained ferrite mass using an agate mortar to obtain a fine nanoparticle powder;
f) fabricating a working electrode by:
i. mixing 90 wt. % of the nanoparticle powder, 5 wt. % carbon black, and 5 wt. % polyvinylidene fluoride (PVDF) in N-Methylpyrrolidone (NMP) to form a slurry;
ii. coating the slurry onto a nickel foam substrate over an area of approximately 1 cm×1 cm;
iii. drying the coated substrate at approximately 50° C. for at least 12 hours;
wherein the NiPrₓFe₂₋ₓO₄ is an active material, polyvinylidene fluoride (PVDF) is a binder, and the carbon black is a conducting material;
g) assembling the working electrode in a three-electrode electrochemical cell configuration comprising the working electrode, a calomel reference electrode, and a platinum wire counter electrode to form the electrochemical device.

2. The process of claim 1, further comprising:
immersing the electrodes in a 3M potassium hydroxide (KOH) aqueous electrolyte; and
i) conducting electrochemical analysis including cyclic voltammetry (CV), galvanostatic charge-discharge (GCD), and electrochemical impedance spectroscopy (EIS) using an instrument equipped with a frequency response analyzer (FRA).

3. The process of claim 1, wherein the value of x in the formula NiPrₓFe₂₋ₓO₄ is selected from the group consisting of 0.000, 0.005, 0.010, 0.015, and 0.020.

4. The process of claim 1, wherein the muffle furnace is maintained at a temperature range of 440°° C. to 460° C.; wherein the crushed powder has an average particle size in the nanometer range and exhibits enhanced electrochemical properties suitable for supercapacitor electrode material; and wherein the pellets are sintered prior to supercapacitor testing to improve structural integrity and conductivity.

5. The process of claim 1, wherein fabricating the working electrode further comprises:
preparing a slurry comprising 90 wt % praseodymium-doped nickel ferrite having the general formula NiPrₓFe₂₋ₓO₄, 5 wt % polyvinylidene fluoride (PVDF) as binder, and 5 wt % carbon black as conductive additive;
dispersing the said components in N-Methyl-2-pyrrolidone (NMP) solvent to form a homogeneous slurry;
coating the slurry over a 1 cm×1 cm area of a nickel foam substrate to form a working electrode; and
drying the coated electrode at approximately 50° C. for overnight to remove the solvent and fix the active material; and wherein the drying time is overnight, preferably 8-12 hours in a temperature-controlled oven.

6. The process of claim 1, wherein prior to initiating the solution combustion synthesis, each precursor-fuel solution is subjected to a staged pre-heating phase at 150° C. for 20 minutes within a convection oven to partially evaporate excess water and promote pre-nucleation of metal complex intermediates, followed by immediate transfer to the preheated muffle furnace at approximately 450° C. to enable self-sustained combustion, wherein the pre-heating reduces abrupt solvent outgassing during combustion and allows for a more uniform combustion front propagation, thereby enhancing phase purity and minimizing porosity gradients in the resulting NiPrₓFe₂₋ₓO₄ nanoparticle aggregates.

7. The process of claim 1, wherein the crushing of the obtained ferrite mass is followed by a controlled thermal tempering protocol wherein the fine nanoparticle powder is placed inside a quartz crucible and subjected to sequential annealing at 500°° C. for 1 hour and then at 650° C. for an additional 2 hours under flowing argon gas at 100 sccm, thereby enabling stress-relief of combustion-induced lattice distortions and facilitating site-specific redistribution of praseodymium ions within the spinel lattice, which contributes to improved structural ordering and reduction of surface-trapped charge states during subsequent electrode operation.

8. The process of claim 1, wherein formation of the slurry is carried out under continuous magnetic stirring at 600 rpm for 6 hours at 60° C. using a sealed glass vessel equipped with a reflux condenser to minimize solvent loss, followed by mechanical homogenization using a triple-roller mill to break any residual agglomerates and achieve uniform dispersion of the active NiPrₓFe₂₋ₓO₄ particles within the PVDF matrix, wherein the solvent medium N-Methylpyrrolidone is additionally filtered through a 0.2 μm PTFE membrane prior to use to eliminate particulates that may interfere with binder distribution and slurry rheology.

9. The process of claim 1, wherein prior to coating the slurry onto the nickel foam substrate, the foam is subjected to a two-step surface activation process comprising an initial immersion in a 1:1 v/v mixture of nitric acid and ethanol for 10 minutes to etch surface oxides, followed by oxygen plasma treatment at 100 W for 5 minutes to generate hydroxyl surface groups, thereby significantly improving the mechanical anchoring and wetting characteristics of the slurry on the 3D foam structure and minimizing delamination of the active layer during solvent drying and subsequent electrolyte exposure.

10. The process of claim 1, wherein the drying of the coated substrate in is conducted under a dual-stage vacuum-assisted drying protocol, wherein the initially coated nickel foam is air-dried at ambient conditions for 2 hours to allow partial solvent evaporation and pre-gelation of the binder, followed by placement in a vacuum oven maintained at 50° C. under 100 mbar pressure for a minimum of 12 hours, wherein the vacuum drying facilitates removal of residual NMP from porous interstices within the foam, ensures deeper infiltration of the active material into the substrate pores, and prevents the formation of binder-rich insulating domains at the air-electrode interface.

11. The process of claim 1, wherein during the adding of the 1:1 ratio of oxidizers and fuels to the each solution, the addition of the fuels to the precursor solutions is performed sequentially by first dissolving urea completely, followed by the gradual addition of glucose under continuous stirring at 70° C. for 30 minutes, wherein the glucose acts as both a reducing agent and a carbon scaffold precursor, and wherein the molar ratio between total fuel content and total oxidizing equivalents is maintained at 1:1.5 to deliberately create a slightly fuel-deficient condition, thereby inducing a high-temperature, short-duration combustion front that favors the formation of low-defect, spinel-structured NiPrₓFe₂₋ₓO₄ nanoparticles with minimal residual carbon.

12. The process of claim 1, wherein the beakers used for the solution combustion synthesis are fabricated from borosilicate glass and are externally wrapped in a ceramic fiber insulating layer to stabilize localized temperature distribution during combustion, and wherein each beaker is positioned at an equidistant radial layout within the muffle furnace chamber using an alumina platform to ensure uniform exposure to the furnace's thermal gradient, thereby minimizing inter-batch variability and promoting reproducible synthesis outcomes across varying dopant concentrations of x.

13. The process of claim 1, wherein the mixing in forming the slurry further comprises the incorporation of a non-ionic dispersing agent selected from the group consisting of polyvinylpyrrolidone (PVP) and polyethylene glycol (PEG), added at a concentration of 0.5-1.0 wt. % relative to the total slurry weight, wherein the dispersing agent adsorbs selectively on the NiPrₓFe₂₋ₓO₄ nanoparticle surfaces to inhibit flocculation and facilitate steric stabilization, thereby improving the slurry's homogeneity, shelf-life, and coating uniformity.

14. The process of claim 1, wherein the nickel foam substrate is pre-compacted using a uniaxial hydraulic press at a pressure of 1.5 MPa for 10 seconds to slightly reduce the pore diameter and increase the foam's mechanical density, thereby enabling better retention and infiltration of the active material during slurry deposition, while still maintaining sufficient open porosity to allow ionic diffusion during device operation.

15. The process of claim 1, wherein the active material slurry is applied to the nickel foam in using a controlled drop-casting method coupled with localized heat-assisted spreading, wherein the substrate is maintained at 60° C. on a temperature-controlled hotplate during slurry deposition to reduce surface tension and accelerate solvent evaporation at the wetting front, thereby enabling more consistent layer formation, enhanced microstructural bonding between the ferrite layer and the metallic substrate, and suppression of cracking or delamination during the drying phase.

16. The process of claim 1, wherein the electrochemical device comprises:
a working electrode comprising a nickel foam current collector coated with a dried slurry containing 90 wt % active material of NiPrₓFe₂₋ₓO₄, 5 wt % polyvinylidene fluoride (PVDF) as a binder, and 5 wt % carbon black as a conducting material;
a calomel reference electrode positioned in electrical contact with the electrolyte;
a platinum wire counter electrode; and
an electrolyte comprising 3M aqueous potassium hydroxide (KOH) solution.

17. The process of claim 16, wherein the electrode is formed using material selected from NiPrₓFe₂₋ₓO₄ with x equal to 0.000, 0.005, 0.010, 0.015, or 0.020; and wherein the working electrode area is approximately 1 cm×1 cm, wherein the electrochemical workstation is configured to apply a CV scan in the range of −1.0 V to 0 V, and perform impedance spectroscopy in the frequency range of 100 kHz to 0.01 Hz.

18. The process of claim 16, wherein the electrochemical device is connected to an electrochemical workstation equipped with a frequency response analyzer (FRA), configured to perform cyclic voltammetry, galvanostatic charge-discharge, and electrochemical impedance measurements.
